(19) United States
(12) Patent Application Publication
(10) Pub. No.: US 2021/0313616 A1
(43) Pub. Date: Oct. 7, 2021

(54) BYPRODUCT FREE METHODS FOR SOLID HYBRID ELECTROLYTE

(71) Applicant: Blue Current, Inc., Hayward, CA (US)

(72) Inventors: Irune Villaluenga, Berkeley, CA (US); Joanna Burdynska, Berkeley, CA (US)

(21) Appl. No.: 17/301,457

(22) Filed: Apr. 2, 2021

Related U.S. Application Data
(60) Provisional application No. 63/005,212, filed on Apr. 4, 2020.

(51) Int. Cl. H01M 10/056; C08K 3/105; H01M 4/62; H01M 50/46; H01M 10/0525

(52) U.S. Cl. CPC H01M 10/056; C08K 3/105; H01M 4/622; H01M 2300/0082; H01M 10/0525; H01M 2300/0091; H01M 2300/0068; H01M 50/46

(57) ABSTRACT

The present disclosure relates to a hybrid electrolyte composition including an ion conducting inorganic material and an in situ cross-linked matrix. Methods and apparatuses including such compositions are also described herein.

### CROSS-REFERENCE TO RELATED APPLICATION

This application claims the benefit of U.S. Provisional Patent Application No. 63/005,212, filed Apr. 4, 2020, which is incorporated herein by reference in its entirety.

### FIELD

The present disclosure relates to a hybrid electrolyte composition including an ion conducting inorganic material and an in situ cross-linked matrix. Methods and apparatuses including such compositions are also described herein.

### BACKGROUND

Solid-state electrolytes present various advantages over liquid electrolytes for primary and secondary batteries. For example, in lithium ion secondary batteries, inorganic solid-state electrolytes may be less flammable than conventional liquid organic electrolytes. Solid-state electrolytes can also facilitate use of a lithium metal electrode by resisting dendrite formation. Solid-state electrolytes may also present advantages of high energy densities, good cycling stabilities, and electrochemical stabilities over a range of conditions. However, there are various challenges in large scale commercialization of solid-state electrolytes. One challenge is maintaining contact between electrolyte and the electrodes. For example, while inorganic materials such as inorganic sulfide glasses and ceramics have high ionic conductivities (over 10⁻⁴ S/cm) at room temperature, they do not serve as efficient electrolytes due to poor adhesion to the electrode during battery cycling. Another challenge is that glass and ceramic solid-state conductors are too brittle to be processed into dense, thin films on a large scale. This can result in high bulk electrolyte resistance due to the films being too thick, as well as dendrite formation, due to the presence of voids that allow dendrite penetration. The mechanical properties of even relatively ductile sulfide glasses are not adequate to process the glasses into dense, thin films. Improving these mechanical properties without sacrificing ionic conductivity is a particular challenge, as techniques to improve adhesion, such as the addition of a solid polymer binder, tend to reduce ionic conductivity. It is not uncommon to observe more than an order of magnitude conductivity decrease with as little as 1 wt. % of binder introduced. Solid-state polymer electrolyte systems may have improved mechanical characteristics that facilitate adhesion and formation into thin films, but have low ionic conductivity at room temperature or poor mechanical strength.

Materials that have high ionic conductivities at room temperature and that are sufficiently compliant to be processed into thin, dense films without sacrificing ionic conductivity are needed for large scale production and commercialization of solid-state batteries.

### SUMMARY

The present disclosure relates to a hybrid electrolyte composition. In a first aspect, the composition includes: about 60 wt. % to about 95 wt. % of an ion conducting inorganic material; and about 5 wt. % to about 40 wt. % of an in situ cross-linked matrix.

In some embodiments, the ion conducting inorganic material includes lithium. In other embodiments, the ion conducting inorganic material is a sulfide-based material.

In some embodiments, the in situ cross-linked matrix includes a binder and a plurality of cross-linkers. Non-limiting binders include a polymer backbone, a copolymer backbone, or a graft copolymer backbone. Other non-limiting binders can include a perfluoroether, an epoxy, a polybutadiene, a poly(styrene-b-butadiene), a polyolefin, a polysiloxane, a polytetrahydrofuran, a polystyrene, a polyethylene, a polybutylene, a poly (styrene-butadiene-styrene) (SBS), a poly (styrene-ethylene-butylene-styrene) (SEBS), a poly (styrene-isoprene-styrene) (SIS), an acrylonitrile butadiene rubber, an ethylene propylene diene monomer polymer, as well as copolymers thereof.

In other embodiments, the binder includes a plurality of inorganic cages. Non-limiting inorganic cages can include silica, silsesquioxane, hydridosilsesquioxane, or partially condensed silsesquioxane. In some embodiments, the plurality of inorganic cages includes (SiO_{1.5})ₙ, wherein n is an integer from 8, 10, or 12. In particular embodiments, the cross-linker is attached to a silicon atom in a first inorganic cage including (SiO_{1.5})ₙ and attached to another silicon atom in a second inorganic cage including (SiO_{1.5})ₙ.

The in situ cross-linked matrix can include a plurality of cross-linkers. In some embodiments, the cross-linkers form a thermally reversible bond within the matrix, wherein the thermally reversible bond does not generate a byproduct. In particular embodiments, the thermally reversible bond is formed by way of a Diels-Alder cycloaddition reaction, a Huisgen cycloaddition reaction, a thiol-ene reaction, a Michael addition reaction, a ring-opening reaction, or a click chemistry reaction.

In other embodiments, the cross-linker has a structure of -L¹-X¹-L²-, -L¹-X¹-L²-X²-L³-, or (-L¹)(-L^{1a})X¹-L²-X²(L³-L^{3a}-), wherein:
each of L¹, L^{1a}, L², L³, and L^{3a} includes, independently, an optionally substituted alkylene, optionally substituted heteroalkylene, or an optionally substituted arylene; and
each of X¹ or X² includes, independently, a Diels-Alder cycloaddition product, a Huisgen cycloaddition product, a thiol-ene reaction product, a Michael addition product, or a ring-opening reaction product.

In some embodiments, each of L¹, L^{1a}, L², L³, and L^{3a} is, independently, an optionally substituted alkylene, optionally substituted heteroalkylene, or an optionally substituted arylene. In other embodiments, each of L¹, L^{1a}, L², L³, and L^{3a} is, independently, -Cy-, -Ak-Cy-, -Het-Cy-, -Cy-Ak-, -Cy-Het-, -Ak-Cy-Ak, -Het-Cy-Het-, —(Ar)ₐ—, -(Ak)_{b}-(O-Ak)ₐ-, or -(Ak-O)_{b}-(Ak)ₐ-, wherein Cy is a divalent linker including a heterocycle or a carbocycle, Ak is an optionally substituted alkylene, Het is an optionally substituted heteroalkylene, and Ar is an optionally substituted arylene; a is an integer from 1 to 10; and b is 0 or 1.

In other embodiments, each of X¹ or X² includes, independently, thio or a divalent linker including a heterocycle or a carbocycle. In particular embodiments, each of X¹ or X² is, independently, a moiety selected from the group consisting of:

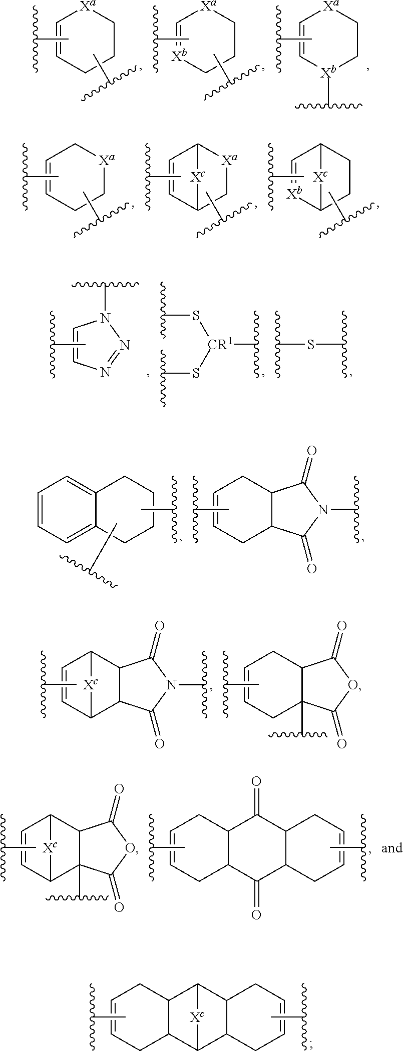

in which X^{a} is —C(R¹)₂—, —NR¹—, —O—, or —S—; X^{b} is ═CR¹— or —N—; X^{c} is —[C(R)₂]_{c1}—, —NR¹—, —O—, —S—, or —C(O)—O—; R¹ is H or optionally substituted alkyl; c1 is an integer from 1 to 3; and wherein the moiety is optionally substituted with cyano, hydroxyl, halo, nitro, carboxyaldehyde, carboxyl, alkoxy, oxo, or alkyl.

In a second aspect, the present disclosure relates to a film including a hybrid electrolyte composition (e.g., any described herein). In some embodiments, an elastic modulus of the film is of from about 0.2 GPa to about 3 GPa.

In a third aspect, the present disclosure relates to a method of forming a hybrid electrolyte composition (e.g., any described herein), the method including: providing a mixture including a binder component bonded to a first linker having a first reactive group and an ion conducting inorganic material; and reacting the binder component with a linking agent to form an in situ cross-linked matrix.

In some embodiments, the method further includes: casting the hybrid electrolyte composition as a film; and optionally healing the film by heating to a temperature of from about 100° C. to about 190° C.

In some embodiments, the linking agent includes a second reactive group configured to react together with the first reactive group to form a thermally reversible bond within the matrix, wherein the thermally reversible bond does not generate a byproduct. In particular embodiments, the first and second reactive groups react together to form a Diels-Alder cycloaddition product, a Huisgen cycloaddition product, a thiol-ene reaction product, a Michael addition product, or a ring-opening reaction product.

In other embodiments, the first and second reactive groups are selected from one of the following pairs: a diene and a dienophile; a 1,3-dipole and a dipolarophile; a thiol and an optionally substituted alkene; a thiol and an optionally substituted alkyne; a nucleophile and a strained heterocyclyl electrophile; a nucleophile and an optionally substituted α,β-unsaturated carbonyl compound; or a nucleophile and an optionally substituted strained cyclic compound. In yet other embodiments, the first and second reactive groups are selected from the group consisting of an optionally substituted 1,3-butadiene, an optionally substituted alkene, optionally substituted alkyne, an optionally substituted α,β-unsaturated aldehyde, an optionally substituted unsaturated α,β-thioaldehyde, an optionally substituted α,β-unsaturated ketone, an optionally substituted azide, an optionally substituted thiol, an optionally substituted unsaturated cycloalkyl, an optionally substituted unsaturated heterocyclyl, an optionally substituted α,β-unsaturated imine, an optionally substituted aldehyde, an optionally substituted imine, an optionally substituted nitroso-compound, an optionally substituted diazene, an optionally substituted thioketone, an optionally substituted α,β-unsaturated ketone, an optionally substituted α,β-unsaturated aldehyde, an optionally substituted anionic nucleophile, and an optionally substituted strained epoxy.

The binder component can provide any useful binder and include any useful monomer. In some embodiments, the binder component includes a monomer bonded to the first linker having the first reactive group. In other embodiments, the binder component includes the following structure: —[R^{M}-(L*-R¹*)]ₙ—, wherein: R^{M} is the monomer; L* is a divalent linker; R¹* is the first reactive group; and n is 1 to 10.

In other embodiments, the monomer includes an optionally substituted styrene monomer, an optionally substituted ethylene monomer, an optionally substituted propylene monomer, an optionally substituted butylene monomer, an optionally substituted butadiene monomer, an optionally substituted perfluoroalkane monomer, an optionally substituted perfluoroether monomer, an optionally substituted isoprene monomer, an optionally substituted ethylidene norbornene monomer, or an optionally substituted diene monomer.

In some embodiments, the binder component includes the following structure: —[R^{M1}]ₙ₁—[R^{M2}]ₙ₂—[R^{M3}-(L*-R¹*)]ₙ₃—[R^{M4}]ₙ₄—, wherein: R^{Ml} is a first monomer; R^{M2} is a second monomer; R^{M3} is a third monomer; R^{M4} is a fourth monomer; L* is a divalent linker; R¹* is the first reactive group; and each of n1, n2, n3, and n4 is, independently, from 0 to 10, in which at least one of n1, n2, n3, and n4 is not 0. In particular embodiments, the first, second, third, and fourth monomer includes an optionally substituted styrene monomer, an optionally substituted ethylene monomer, an optionally substituted propylene monomer, an optionally substituted butylene monomer, an optionally substituted butadiene monomer, an optionally substituted perfluoroalkane monomer, an optionally substituted perfluoroether monomer, an optionally substituted isoprene monomer, an optionally substituted ethylidene norbornene monomer, or an optionally substituted diene monomer.

In other embodiments, the binder component includes an inorganic cage bonded to the first linker having the first reactive group. In particular embodiments, the binder component has the following structure: R^{C}-(L*-R¹*)ₙ, wherein: R^{C} is the inorganic cage; L* is a divalent linker; R¹* is the first reactive group; and n is 8, 10, or 12. In some embodiments, R^{C} is (SiO_{1.5})ₙ.

In any embodiment herein (e.g., in the binder component), at least one L* (a divalent linker) is independently, -Cy-, -Ak-Cy-, -Het-Cy-, -Cy-Ak-, -Cy-Het-, -Ak-Cy-Ak, -Het-Cy-Het-, —(Ar)ₐ—, -(Ak)_{b}-(O-Ak)ₐ-, or -(Ak-O)_{b}-(Ak)ₐ-, in which Cy is a divalent linker including a heterocycle or a carbocycle, Ak is an optionally substituted alkylene, Het is an optionally substituted heteroalkylene, and Ar is an optionally substituted arylene; a is an integer from 1 to 10; and b is 0 or 1.

In any embodiment herein, R¹* (a first reactive group, e.g., in the binder component) is selected from an optionally substituted diene, an optionally substituted unsaturated heterocyclyl, an optionally substituted α,β-unsaturated aldehyde, an optionally substituted α,β-unsaturated thioaldehyde, an optionally substituted α,β-unsaturated imine, an optionally substituted azide, or an optionally substituted thiol.

Any useful linking agent can be used to form the in situ cross-linked matrix. In some embodiments, the linking agent further includes a third reactive group, wherein at least one of the first and second reactive groups react together to form a thermally reversible bond within matrix, and wherein another first reactive group and the third reactive group reacts together to form another thermally reversible bond. In particular embodiments, the second and third reactive groups are the same.

In some embodiments, the linking agent has the following structure: R²*-L*-R³*, wherein: R²* is the second reactive group; L* is a divalent linker; and R³* is the third reactive group. In particular embodiments, each of R²* and R³* is independently selected from the group consisting of an optionally substituted alkene, an optionally substituted alkyne, an optionally substituted unsaturated cycloalkyl, an optionally substituted heterocyclyl, an optionally substituted imine, an optionally substituted nitroso compound, an optionally substituted azo compound, an optionally substituted thioketone, an optionally substituted thiophosphate, and an optionally substituted thione oxide compound.

In any embodiment herein (e.g., in the linking agent), L* is independently, -Cy-, -Ak-Cy-, -Het-Cy-, -Cy-Ak-, -Cy-Het-, -Ak-Cy-Ak, -Het-Cy-Het-, —(Ar)ₐ—, -(Ak)_{b}-(O-Ak)ₐ-, or -(Ak-O)_{b}-(Ak)ₐ-, in which Cy is a divalent linker including a heterocycle or a carbocycle, Ak is an optionally substituted alkylene, Het is an optionally substituted heteroalkylene, and Ar is an optionally substituted arylene; a is an integer from 1 to 10; and b is 0 or 1.

In any embodiment herein, the thermally reversible bond is formed by way of a Diels-Alder cycloaddition reaction, a Huisgen cycloaddition reaction, a thiol-ene reaction, a Michael addition reaction, a ring-opening reaction, or a click chemistry reaction. In particular embodiments, the thermally reversible bond includes a Diels-Alder cycloaddition product, a Huisgen cycloaddition product, a thiol-ene reaction product, a Michael addition product, or a ring-opening reaction product. In other embodiments, the thermally reversible bond includes thio, an optionally substituted heterocyclyl, or an optionally substituted cycloalkyl. In yet other embodiments, the thermally reversible bond includes a moiety selected from the group consisting of:

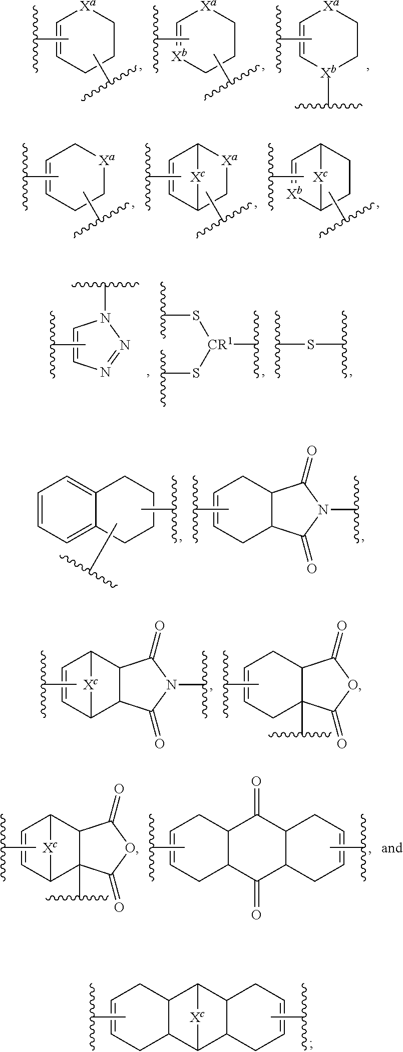

wherein: X^{a} is —C(R¹)₂—, —NR¹—, —O—, or —S—; X^{b} is ═CR¹— or —N—; X^{c} is —[C(R¹)₂]_{c1}—, —NR¹—, —O—, —S—, or —C(O)—O—; R¹ is H or optionally substituted alkyl; c1 is an integer from 1 to 3; and wherein the moiety is optionally substituted with cyano, hydroxyl, halo, nitro, carboxyaldehyde, carboxyl, alkoxy, oxo, or alkyl.

In a fourth aspect, the present disclosure includes a battery including any composition or any film described herein.

In a fifth aspect, the present disclosure includes an electrode including any composition or any film described herein.

In a sixth aspect, the present disclosure includes an electrode including: an in situ cross-linked matrix; an electrochemically active material; and ionically conductive particles. In some embodiment, the electrode includes an optionally carbon additive. In particular embodiments, the carbon additive is an electronically conductive carbon-based additive (e.g., activated carbon, carbon nanotubes, graphene, graphite, carbon fibers, carbon black, or any described herein). In other embodiments, the electrode is an anode or a cathode. In yet other embodiments, the carbon additive is provided to the anode, the cathode, or both.

In some embodiments, the in situ cross-linked matrix includes a binder and a plurality of crosslinkers, wherein the crosslinkers form a thermally reversible bond within the matrix and wherein the thermally reversible bond does not generate a byproduct.

In a seventh aspect, the present disclosure includes a composition including: a separator including ion conducting inorganic material and an in situ cross-linked first matrix; and an electrode. In some embodiments, the electrode includes an in situ cross-linked second matrix, wherein the first matrix and the second matrix include a binder and a plurality of crosslinkers, wherein the crosslinkers form a thermally reversible bond between the matrices, and wherein the thermally reversible bond does not generate a byproduct.

In an eighth aspect, the present disclosure includes a method including: providing an electrode and a separator composition; and reacting the binder component of the electrode and the separator composition with a linking agent to form an in situ cross-linked matrix between the electrode and the separator composition. In some embodiments, the electrode and the separator composition each includes a binder component bonded to a first linker having a first reactive group. In other embodiments, the linking agent includes a second reactive group configured to react together with the first reactive group to form a thermally reversible bond within the matrix, wherein the thermally reversible bond does not generate a byproduct. Additional details follow.

### BRIEF DESCRIPTION OF THE DRAWINGS

FIG. 1 shows a schematic providing non-limiting examples of cross-linkers, including compounds (I-1) to (I-8). Such compounds can be thiols and alkenes/alkynes used in thiol-ene polymerizations.

FIG. 2A-2B shows schematics providing non-limiting examples of (A) all-carbon dienes including compounds (II-1) to (II-10); and (B) heteroatom dienes including compounds (II-11) to (II-14), which can undergo a Diels-Alder reaction.

FIG. 3A-3B shows schematics providing non-limiting examples of (A) all-carbon dienophiles including compounds (III-1) to (III-11); and (B) heteroatom dienophiles including compounds (III-12) to (III-19), which can undergo a Diels-Alder reaction.

FIG. 4A-4D shows schematics providing non-limiting examples of (A) a polymer with a diene/dienophile as end groups of the polymer backbone; (B) a polymer with a diene/dienophile on the main chain of the polymer backbone; (C) a polymer with a diene/dienophile on a chain graft extending off of the polymer backbone, in which the diene/dienophile can be incorporated directly during polymerization; and (D) a polymer that can be post-functionalized to include a diene/dienophile modifying the reactive group.

FIG. 5 shows schematics providing non-limiting examples of monomers and cross-linkers, including compounds (V-1) to (V-7).

FIG. 6 is a graph showing thermogravimetric analysis (TGA) of polystyrene-b-poly(ethylene-ran-butylene)-b-polystyrene-g-maleic anhydride (SEBS-gMA).

FIG. 7 is a graph showing Fourier-transform infrared spectroscopy (FTIR) spectra of SEBS-gMA and furfuryl-modified SEBS (SEBS-gFA).

FIG. 8 is a graph showing proton nuclear magnetic resonance (¹H NMR) spectra of SEBS-gMA (black) and SEBS-gFA (gray) conducted in CDCl₃ on a 700 MHz instrument.

FIG. 9 is a graph showing stress-strain curves for a SEBS film (thick black line), a SEBS-gMA film (thin black line), a SEBS-gFA film (dashed line), and a SEBS-gFA+0.5BMI film (gray line) tested at 0.05 in/min rate.

FIG. 10 is a graph showing stress-strain analysis of non-limiting hybrid electrolyte compositions prepared with 75:25=Li₂S:P₂S₅ conductor and 20 wt. % of SEBS (gray line), SEBS-gMA (dashed line), SEBS-gFA (thick black line), and BMI-crosslinked SEBS-gFA (thin black line) binders tested at 0.05 in/min rate.

FIG. 11A-11C shows schematics of non-limiting cells according to certain embodiments of the invention. Provided are cells including (A) an anode 104 disposed between a current collector 102 and an electrolyte/separator 106; (B) a current collector 102 adjacent to an electrolyte/separator 106; and (C) an anode 104 disposed between a current collector 102 and an electrolyte/cathode bilayer 112.

FIG. 12 shows a schematic of cross-linking components to provide a cross-linked film 1206.

### DETAILED DESCRIPTION

One aspect of the present invention relates to ionically conductive solid-state compositions that include ionically conductive inorganic particles in a matrix of an organic material. The resulting composite material has high ionic conductivity and mechanical properties that facilitate processing. In particular embodiments, the ionically conductive solid-state compositions are compliant and may be cast as films.

Another aspect of the present invention relates to batteries that include the ionically conductive solid-state compositions described herein. In some embodiments of the present invention, solid-state electrolytes including the ionically conductive solid-state compositions are provided. In some embodiments of the present invention, electrodes including the ionically conductive solid-state compositions are provided.

Particular embodiments of the subject matter described herein may have the following advantages. In some embodiments, the ionically conductive solid-state compositions may be processed to a variety of shapes with easily scaled-up manufacturing techniques. The manufactured composites are compliant, allowing good adhesion to other components of a battery or other device. The solid-state compositions have high ionic conductivity, allowing the compositions to be used as electrolytes or electrode materials. In some embodiments, ionically conductive solid-state compositions enable the use of lithium metal anodes by resisting dendrites. In some embodiments, the ionically conductive solid-state compositions do not dissolve polysulfides and enable the use of sulfur cathodes.

Further details of the ionically conductive solid-state compositions, solid-state electrolytes, electrodes, and batteries according to embodiments of the present invention are described below.

The ionically conductive solid-state compositions may be referred to as hybrid compositions herein. The term “hybrid” is used herein to describe a composite material including an inorganic phase and an organic phase. The term “composite” is used herein to describe a composite of an inorganic material and an organic material.

In some embodiments, the composite materials are formed from a precursor that is polymerized in situ after being mixed with inorganic particles. The polymerization may take place under applied pressure that causes particle-to-particle contact. Once polymerized, applied pressure may be removed with the particles immobilized by the polymer matrix. In some implementations, the organic material includes a cross-linked polymer network. This network may constrain the inorganic particles and prevents them from shifting during operation of a battery or other device that incorporates the composite.

In some embodiments, the polymerization may cause particle-to-particle contact without applied external pressure. For example, certain polymerization reactions that include cross-linking may lead to sufficient contraction that particle-to-particle contact and high conductivity is achieved without applied pressure during the polymerization.

The polymer precursor and the polymer matrix are compatible with the solid-state ionically conductive particles, non-volatile, and non-reactive to battery components such as electrodes. The polymer precursor and the polymer matrix may be further characterized by being non-polar or having low-polarity. The polymer precursor and the polymer matrix may interact with the inorganic phase such that the components mix uniformly and microscopically well, without affecting at least the composition of the bulk of the inorganic phase. Interactions can include one or both of physical interactions or chemical interactions. Examples of physical interactions include hydrogen bonds, van der Waals bonds, electrostatic interactions, and ionic bonds. Chemical interactions refer to covalent bonds. A polymer matrix that is generally non-reactive to the inorganic phase may still form bonds with the surface of the particles, but does not degrade or change the bulk composition of the inorganic phase. In some embodiments, the polymer matrix may mechanically interact with the inorganic phase.

The term “number average molecular weight” or “Mₙ” in reference to a particular component (e.g., a high molecular weight polymer binder) of a solid-state composition refers to the statistical average molecular weight of all molecules of the component expressed in units of g/mol. The number average molecular weight may be determined by techniques known in the art such as, for example, gel permeation chromatography (wherein Mₙ can be calculated based on known standards based on an online detection system such as a refractive index, ultraviolet, or other detector), viscometry, mass spectrometry, or colligative methods (e.g., vapor pressure osmometry, end-group determination, or proton NMR). The number average molecular weight is defined by the equation below,

$${M}_{n} = \frac{\sum {N}_{i} {M}_{i}}{\sum {N}_{i}}$$

wherein Mᵢ is the molecular weight of a molecule and Nᵢ is the number of molecules of that molecular weight.

The term “weight average molecular weight” or “M_{w}” in reference to a particular component (e.g., a high molecular weight polymer binder) of a solid-state composition refers to the statistical average molecular weight of all molecules of the component taking into account the weight of each molecule in determining its contribution to the molecular weight average, expressed in units of g/mol. The higher the molecular weight of a given molecule, the more that molecule will contribute to the M_{w} value. The weight average molecular weight may be calculated by techniques known in the art which are sensitive to molecular size such as, for example, static light scattering, small angle neutron scattering, X-ray scattering, and sedimentation velocity. The weight average molecular weight is defined by the equation below,

$${M}_{w} = \frac{\sum {N}_{i} {M}_{i}^{2}}{\sum {N}_{i} {M}_{i}}$$

wherein Mᵢ is the molecular weight of a molecule and Nᵢ is the number of molecules of that molecular weight. In the description below, references to molecular weights of particular polymers refer to number average molecular weight.

By “alkoxy” is meant —OR, where R is an optionally substituted alkyl group, as described herein. Exemplary alkoxy groups include methoxy, ethoxy, butoxy, trihaloalkoxy, such as trifluoromethoxy, etc. The alkoxy group can be substituted or unsubstituted. For example, the alkoxy group can be substituted with one or more substitution groups, as described herein for alkyl. Exemplary unsubstituted alkoxy groups include C₁₋₃, C₁₋₆, C₁₋₁₂, C₁₋₁₆, C₁₋₁₈, C₁₋₂₀, or C₁₋₂₄ alkoxy groups.

The term “alkyl” as used herein alone or as part of another group, refers to a straight or branched chain hydrocarbon containing any number of carbon atoms and that include no double or triple bonds in the main chain. “Lower alkyl” as used herein, is a subset of alkyl and refers to a straight or branched chain hydrocarbon group containing from 1 to 6 carbon atoms. The terms “alkyl” and “lower alkyl” include both substituted and unsubstituted alkyl or lower alkyl unless otherwise indicated. Examples of lower alkyl include methyl, ethyl, n-propyl, iso-propyl, n-butyl, iso-butyl, tert-butyl, and the like.

The alkyl group can also be substituted or unsubstituted. For example, the alkyl group can be substituted with one, two, three or, in the case of alkyl groups of two carbons or more, four substituents independently selected from the group consisting of: (1) C₁₋₆ alkoxy (e.g., —O-Ak, wherein Ak is optionally substituted C₁₋₆ alkyl); (2) C₁₋₆ alkylsulfinyl (e.g., —S(O)-Ak, wherein Ak is optionally substituted C₁₋₆ alkyl); (3) C₁₋₆ alkylsulfonyl (e.g., —SO₂-Ak, wherein Ak is optionally substituted C₁₋₆ alkyl); (4) amino (e.g., —NR^{N1}R^{N2} where each of R^{N1} and R^{N2} is, independently, H or optionally substituted alkyl, or R^{N1} and R^{N2}, taken together with the nitrogen atom to which each are attached, form a heterocyclyl group); (5) aryl; (6) arylalkoxy (e.g., —O-L-Ar, wherein L is a bivalent form of optionally substituted alkyl and Ar is optionally substituted aryl); (7) aryloyl (e.g., —C(O)—Ar, wherein Ar is optionally substituted aryl); (8) azido (e.g., —N₃); (9) cyano (e.g., —CN); (10) carboxyaldehyde (e.g., —C(O)H); (11) C₃₋₈ cycloalkyl (e.g., a monovalent saturated or unsaturated non-aromatic cyclic C₃₋₈ hydrocarbon group); (12) halo (e.g., F, Cl, Br, or I); (13) heterocyclyl (e.g., a 5-, 6- or 7-membered ring, unless otherwise specified, containing one, two, three, or four non-carbon heteroatoms, such as nitrogen, oxygen, phosphorous, sulfur, or halo); (14) heterocyclyloxy (e.g., —O-Het, wherein Het is heterocyclyl, as described herein); (15) heterocyclyloyl (e.g., —C(O)—Het, wherein Het is heterocyclyl, as described herein); (16) hydroxyl (e.g., —OH); (17) N-protected amino; (18) nitro (e.g., —NO₂); (19) oxo (e.g., ═O); (20) C₃₋₈ spirocyclyl (e.g., an alkylene or heteroalkylene diradical, both ends of which are bonded to the same carbon atom of the parent group); (21) C₁₋₆ thioalkoxy (e.g., —S-Ak, wherein Ak is optionally substituted C₁₋₆ alkyl); (22) thiol (e.g., —SH); (23) —CO₂R^{A}, where R^{A} is selected from the group consisting of (a) hydrogen, (b) C₁₋₆ alkyl, (c) C₄₋₁₈ aryl, and (d) (C₄₋₁₈ aryl) C₁₋₆ alkyl (e.g., -L-Ar, wherein L is a bivalent form of optionally substituted alkyl group and Ar is optionally substituted aryl); (24) —C(O)NR^{B}R^{C}, where each of R^{B} and R^{C} is, independently, selected from the group consisting of (a) hydrogen, (b) C₁₋₆ alkyl, (c) C₄₋₁₈ aryl, and (d) (C₄₋₁₈ aryl) C₁₋₆ alkyl (e.g., -L-Ar, wherein L is a bivalent form of optionally substituted alkyl group and Ar is optionally substituted aryl); (25) —SO₂R^{D}, where R^{D} is selected from the group consisting of (a) C₁₋₆ alkyl, (b) C₄₋₁₈ aryl, and (c) (C₄₋₁₈ aryl) C₁₋₆ alkyl (e.g., -L-Ar, wherein L is a bivalent form of optionally substituted alkyl group and Ar is optionally substituted aryl); (26) —SO₂NR^{E}R^{F}, where each of R^{E} and R^{F} is, independently, selected from the group consisting of (a) hydrogen, (b) C₁₋₆ alkyl, (c) C₄₋₁₈ aryl, and (d) (C₄₋₁₈ aryl) C₁₋₆ alkyl (e.g., -L-Ar, wherein L is a bivalent form of optionally substituted alkyl group and Ar is optionally substituted aryl); and (27) —NR^{G}R^{H}, where each of R^{G} and R^{H} is, independently, selected from the group consisting of (a) hydrogen, (b) an N-protecting group, (c) C₁₋₆ alkyl, (d) C₂₋₆ alkenyl (e.g., optionally substituted alkyl having one or more double bonds), (e) C₂₋₆ alkynyl (e.g., optionally substituted alkyl having one or more triple bonds), (f) C₄₋₁₈ aryl, (g) (C₄₋₁₈ aryl) C₁₋₆ alkyl (e.g., L-Ar, wherein L is a bivalent form of optionally substituted alkyl group and Ar is optionally substituted aryl), (h) C₃₋₈ cycloalkyl, and (i) (C₃₋₈ cycloalkyl) C₁₋₆ alkyl (e.g., -L-Cy, wherein L is a bivalent form of optionally substituted alkyl group and Cy is optionally substituted cycloalkyl, as described herein), wherein in one embodiment no two groups are bound to the nitrogen atom through a carbonyl group or a sulfonyl group. The alkyl group can be a primary, secondary, or tertiary alkyl group substituted with one or more substituents (e.g., one or more halo or alkoxy). In some embodiments, the unsubstituted alkyl group is a C₁₋₃, C₁₋₆, C₁₋₁₂, C₁₋₁₆, C₁₋₁₈, C₁₋₂₀, or C₁₋₂₄ alkyl group.

By “alkylene” is meant a multivalent (e.g., bivalent) form of an alkyl group, as described herein. Exemplary alkylene groups include methylene, ethylene, propylene, butylene, etc. In some embodiments, the alkylene group is a C₁₋₃, C₁₋₆, C₁₋₁₂, C₁₋₁₆, C₁₋₁₈, C₁₋₂₀, C₁₋₂₄, C₂₋₃, C₂₋₆, C₂₋₁₂, C₂₋₁₆, C₂₋₁₈, C₂₋₂₀, or C₂₋₂₄ alkylene group. The alkylene group can be branched or unbranched. The alkylene group can also be substituted or unsubstituted. For example, the alkylene group can be substituted with one or more substitution groups, as described herein for alkyl.

The term “aryl” as used herein refers to groups that include monocyclic and bicyclic aromatic groups. Examples include phenyl, benzyl, anthracenyl, anthryl, benzocyclobutenyl, benzocyclooctenyl, biphenylyl, chrysenyl, dihydroindenyl, fluoranthenyl, indacenyl, indenyl, naphthyl, phenanthryl, phenoxybenzyl, picenyl, pyrenyl, terphenyl, and the like, including fused benzo-C₄₋₈ cycloalkyl radicals (e.g., as defined herein) such as, for instance, indanyl, tetrahydronaphthyl, fluorenyl, and the like. The term aryl also includes heteroaryl, which is defined as a group that contains an aromatic group that has at least one heteroatom incorporated within the ring of the aromatic group. Examples of heteroatoms include, but are not limited to, nitrogen, oxygen, sulfur, and phosphorus. Likewise, the term non-heteroaryl, which is also included in the term aryl, defines a group that contains an aromatic group that does not contain a heteroatom. The aryl group can be substituted or unsubstituted. The aryl group can be substituted with one, two, three, four, or five substituents independently selected from the group consisting of: (1) C₁₋₆ alkanoyl (e.g., —C(O)-Ak, wherein Ak is optionally substituted C₁₋₆ alkyl); (2) C₁₋₆ alkyl; (3) C₁₋₆ alkoxy (e.g., —O-Ak, wherein Ak is optionally substituted C₁₋₆ alkyl); (4) C₁₋₆ alkoxy-C₁₋₆ alkyl (e.g., -L-O-Ak, wherein L is a bivalent form of optionally substituted alkyl group and Ak is optionally substituted C₁₋₆ alkyl); (5) C₁₋₆ alkylsulfinyl (e.g., —S(O)-Ak, wherein Ak is optionally substituted C₁₋₆ alkyl); (6) C₁₋₆ alkylsulfinyl-C₁₋₆ alkyl (e.g., -L-S(O)-Ak, wherein L is a bivalent form of optionally substituted alkyl group and Ak is optionally substituted C₁₋₆ alkyl); (7) C₁₋₆ alkylsulfonyl (e.g., —SO₂-Ak, wherein Ak is optionally substituted C₁₋₆ alkyl); (8) C₁₋₆ alkylsulfonyl-C₁₋₆ alkyl (e.g., -L-SO₂-Ak, wherein L is a bivalent form of optionally substituted alkyl group and Ak is optionally substituted C₁₋₆ alkyl); (9) aryl; (10) amino (e.g., —NR^{N1}R^{N2}, where each of R^{N1} and R^{N2} is, independently, H or optionally substituted alkyl, or R^{N1} and R^{N2}, taken together with the nitrogen atom to which each are attached, form a heterocyclyl group); (11) C₁₋₆ aminoalkyl (e.g., an alkyl group, as defined herein, substituted by one or more —NR^{N1}R^{N2} groups, as described herein); (12) heteroaryl (e.g., a subset of heterocyclyl groups (e.g., a 5-, 6- or 7-membered ring, unless otherwise specified, containing one, two, three, or four non-carbon heteroatoms), which are aromatic); (13) (C₄₋₁₈ aryl) C₁₋₆ alkyl (e.g., -L-Ar, wherein L is a bivalent form of optionally substituted alkyl and Ar is optionally substituted aryl); (14) aryloyl (e.g., —C(O)—Ar, wherein Ar is optionally substituted aryl); (15) azido (e.g., N₃ or —N═N—); (16) cyano (e.g., —CN); (17) C₁₋₆ azidoalkyl (e.g., an alkyl group, as defined herein, substituted by one or more azido groups, as described herein); (18) carboxyaldehyde (e.g., —C(O)H); (19) carboxyaldehyde-C₁₋₆ alkyl (e.g., an alkyl group, as defined herein, substituted by one or more carboxyaldehyde groups, as described herein); (20) C₃₋₈ cycloalkyl (e.g., a monovalent saturated or unsaturated non-aromatic cyclic C₃₋₈ hydrocarbon group); (21) (C₃₋₈ cycloalkyl) C₁₋₆ alkyl (e.g., an alkyl group, as defined herein, substituted by one or more cycloalkyl groups, as described herein); (22) halo (e.g., F, Cl, Br, or I); (23) C₁₋₆ haloalkyl (e.g., an alkyl group, as defined herein, substituted by one or more halo groups, as described herein); (24) heterocyclyl (e.g., a 5-, 6- or 7-membered ring, unless otherwise specified, containing one, two, three, or four non-carbon heteroatoms, such as nitrogen, oxygen, phosphorous, sulfur, or halo); (25) heterocyclyloxy (e.g., —O-Het, wherein Het is heterocyclyl, as described herein); (26) heterocyclyloyl (e.g., —C(O)—Het, wherein Het is heterocyclyl, as described herein); (27) hydroxyl (e.g., —OH); (28) C₁₋₆ hydroxyalkyl (e.g., an alkyl group, as defined herein, substituted by one or more hydroxyl, as described herein); (29) nitro (e.g., —NO₂); (30) C₁₋₆ nitroalkyl (e.g., an alkyl group, as defined herein, substituted by one or more nitro, as described herein); (31) N-protected amino; (32) N-protected amino-C₁₋₆ alkyl (e.g., an alkyl group, as defined herein, substituted by one or more N-protected amino groups); (33) oxo (e.g., ═O); (34) C₁₋₆ thioalkoxy (e.g., —S-Ak, wherein Ak is optionally substituted C₁₋₆ alkyl); (35) thio-C₁₋₆ alkoxy-C₁₋₆ alkyl (e.g., -L-S-Ak, wherein L is a bivalent form of optionally substituted alkyl and Ak is optionally substituted C₁₋₆ alkyl); (36) —(CH₂)ᵣCO₂R^{A}, where r is an integer of from zero to four, and R^{A} is selected from the group consisting of (a) hydrogen, (b) C₁₋₆ alkyl, (c) C₄₋₁₈ aryl, and (d) (C₄₋₁₈ aryl) C₁₋₆ alkyl (e.g., -L-Ar, wherein L is a bivalent form of optionally substituted alkyl and Ar is optionally substituted aryl); (37) —(CH₂)ᵣCONR^{B}R^{C}, where r is an integer of from zero to four and where each R^{B} and R^{C} is independently selected from the group consisting of (a) hydrogen, (b) C₁₋₆ alkyl, (c) C₄₋₁₈ aryl, and (d) (C₄₋₁₈ aryl) C₁₋₆ alkyl (e.g., -L-Ar, wherein L is a bivalent form of optionally substituted alkyl and Ar is optionally substituted aryl); (38) —(CH₂)ᵣSO₂R^{D}, where r is an integer of from zero to four and where R^{D} is selected from the group consisting of (a) C₁₋₆ alkyl, (b) C₄₋₁₈ aryl, and (c) (C₄₋₁₈ aryl) C₁₋₆ alkyl (e.g., -L-Ar, wherein L is a bivalent form of optionally substituted alkyl and Ar is optionally substituted aryl); (39) —(CH₂)ᵣSO₂NR^{E}R^{F}, where r is an integer of from zero to four and where each of R^{E} and R^{F} is, independently, selected from the group consisting of (a) hydrogen, (b) C₁₋₆ alkyl, (c) C₄₋₁₈ aryl, and (d) (C₄₋₁₈ aryl) C₁₋₆ alkyl (e.g., -L-Ar, wherein L is a bivalent form of optionally substituted alkyl and Ar is optionally substituted aryl); (40) —(CH₂)ᵣNR^{G}R^{H}, where r is an integer of from zero to four and where each of R^{G} and R^{H} is, independently, selected from the group consisting of (a) hydrogen, (b) an N-protecting group, (c) C₁₋₆ alkyl, (d) C₂₋₆ alkenyl (e.g., optionally substituted alkyl having one or more double bonds), (e) C₂₋₆ alkynyl (e.g., optionally substituted alkyl having one or more triple bonds), (f) C₄₋₁₈ aryl, (g) (C₄₋₁₈ aryl) C₁₋₆ alkyl (e.g., -L-Ar, wherein L is a bivalent form of optionally substituted alkyl and Ar is optionally substituted aryl), (h) C₃₋₈ cycloalkyl, and (i) (C₃₋₈ cycloalkyl) C₁₋₆ alkyl (e.g., -L-Cy, wherein L is a bivalent form of optionally substituted alkyl and Cy is optionally substituted cycloalkyl, as described herein), wherein in one embodiment no two groups are bound to the nitrogen atom through a carbonyl group or a sulfonyl group; (41) thiol (e.g., —SH); (42) perfluoroalkyl (e.g., an alkyl group having each hydrogen atom substituted with a fluorine atom); (43) perfluoroalkoxy (e.g., —OR^{f}, where R^{f} is an alkyl group having each hydrogen atom substituted with a fluorine atom); (44) aryloxy (e.g., —OAr, where Ar is optionally substituted aryl); (45) cycloalkoxy (e.g., —O-Cy, wherein Cy is optionally substituted cycloalkyl, as described herein); (46) cycloalkylalkoxy (e.g., —O-L-Cy, wherein L is a bivalent form of optionally substituted alkyl and Cy is optionally substituted cycloalkyl, as described herein); and (47) arylalkoxy (e.g., —O-L-Ar, wherein L is a bivalent form of optionally substituted alkyl and Ar is optionally substituted aryl). In particular embodiments, an unsubstituted aryl group is a C₄₋₁₈, C₄₋₁₄, C₄₋₁₂, C₄₋₁₀, C₆₋₁₈, C₆₋₁₄, C₆₋₁₂, or C₆₋₁₀ aryl group.

By “arylene” is meant a multivalent (e.g., bivalent) form of an aryl group, as described herein. Exemplary arylene groups include phenylene, naphthylene, biphenylene, triphenylene, diphenyl ether, acenaphthenylene, anthrylene, or phenanthrylene. In some embodiments, the arylene group is a C₄₋₁₈, C₄₋₁₄, C₄₋₁₂, C₄₋₁₀, C₆₋₁₈, C₆₋₁₄, C₆₋₁₂, or C₆₋₁₀ arylene group. The arylene group can be branched or unbranched. The arylene group can also be substituted or unsubstituted. For example, the arylene group can be substituted with one or more substitution groups, as described herein for aryl.

By “carbocycle” is meant a cyclic compound in which all of the ring members are carbon atoms. The carbocycle can be substituted or unsubstituted. Exemplary substitutions include cyano, hydroxyl, halo, nitro, carboxyaldehyde, carboxyl, alkoxy, oxo, or alkyl. Non-limiting carbocycles include cyclohexene, norbornene, naphthalene, tetrahydronaphthalene (e.g., 1,2,3,4-tetrahydronaphthalene), hydroanthraquinone (e.g., 1,4,4a,5,8,8a,9a,10a-octahydroanthracene-9,10-dione), and bridged multicyclic structures (e.g., tetracyclo[6.6.1.02,7.09,14]pentadeca-4,11-diene).

By “carboxyaldehyde” is meant a —C(O)H group.

By “carboxyl” is meant a —CO₂H group.

By “cyano” is meant a —CN group.

By “cycloalkyl” is meant a monovalent saturated or unsaturated non-aromatic cyclic hydrocarbon group of from three to ten carbons (e.g., C₃₋₈ or C₃₋₁₀), unless otherwise specified, and is exemplified by cyclopropyl, cyclobutyl, cyclopentyl, cyclohexyl, cycloheptyl, bicyclo[2.2.1.]heptyl, and the like. The term cycloalkyl also includes “cycloalkenyl,” which is defined as a non-aromatic carbon-based ring composed of three to ten carbon atoms and containing at least one double bound, i.e., C═C. Examples of cycloalkenyl groups include, but are not limited to, cyclopropenyl, cyclobutenyl, cyclopentenyl, cyclopentadienyl, cyclohexenyl, cyclohexadienyl, and the like. The cycloalkyl group can also be substituted or unsubstituted. For example, the cycloalkyl group can be substituted with one or more groups including those described herein for alkyl.

By “halo” is meant F, Cl, Br, or I.

By “heteroalkylene” is meant a bivalent form of an alkylene group, as defined herein, containing one, two, three, or four non-carbon heteroatoms (e.g., independently selected from the group consisting of nitrogen, oxygen, phosphorous, sulfur, selenium, or halo). The heteroalkylene group can be substituted or unsubstituted. For example, the heteroalkylene group can be substituted with one or more substitution groups, as described herein for alkyl.

By “heterocycle” is meant a compound having one or more heterocyclyl moieties. The heterocycle can be substituted or unsubstituted. Exemplary substitutions include cyano, hydroxyl, halo, nitro, carboxyaldehyde, carboxyl, alkoxy, oxo, or alkyl. Non-limiting heterocycles include tetrahydropyridine (e.g., 1,2,3,4-tetrahydropyridine, 1,2,3,6-tetrahydropyridine, or 2,3,4,5-tetrahydropyridine), tetrahydropyrazine (e.g., 1,2,3,4-tetrahydropyrazine); tetrahydropyrimidine (e.g., 1,4,5,6-tetrahydropyrimidine), dihydropyran (e.g., 3,4-dihydro-2H-pyran or 3,6-dihydro-2H-pyran), dihydrothiopyran (e.g., 3,4-dihydro-2H-thiopyran or 3,6-dihydro-2H-thiopyran), dihydrooxazine (e.g., 5,6-dihydro-4H-1,3-oxazine or 3,4-dihydro-2H-1,4-oxazine), dihydrothiazine (e.g., 5,6-dihydro-4H-1,3-thiazine or 5,6-dihydro-4H-1,4-thiazine), heterobicycloheptene (e.g., 7-oxabicyclo[2.2.1]hept-2-ene), bridged isoindole anhydride (e.g., 3a,4,7,7a-tetrahydro-4,7-epoxyisoindole-1,3-dione), bridged benzofuran anhydride (e.g., 3a,4,7,7a-tetrahydro-4,7-epoxyisobenzofuran-1,3-dione), tetrahydrophthalic anhydride (e.g., 1,2,3,6-tetrahydrophthalic anhydride), heteronorbornene (e.g., 7-thianorbornene or 7-azanorbornene), a cyclic anhydride (e.g., a 3-, 4-, 5-, 6- or 7-membered ring (e.g., a 5-, 6- or 7-membered ring), unless otherwise specified, having a —C(O)—O—C(O)— group within the ring), or a cyclic imide (e.g., a 3-, 4-, 5-, 6- or 7-membered ring (e.g., a 5-, 6- or 7-membered ring), unless otherwise specified, having a —C(O)—NR^{N1}—C(O)— group within the ring, where R^{N1} is H, optionally substituted alkyl, or optionally substituted aryl). Exemplary cyclic anhydride groups include a radical formed from succinic anhydride, glutaric anhydride, maleic anhydride, phthalic anhydride, isochroman-1,3-dione, oxepanedione, tetrahydrophthalic anhydride, hexahydrophthalic anhydride, pyromellitic dianhydride, naphthalic anhydride, 1,2-cyclohexanedicarboxylic anhydride, etc., by removing one or more hydrogen. Other exemplary cyclic anhydride groups include dioxotetrahydrofuranyl, dioxodihydroisobenzofuranyl, etc. Exemplary cyclic imide groups include a radical formed from succinimide, glutaric imide, maleimide, phthalimide, tetrahydrophthalimide, hexahydrophthalimide, pyromellitic diimide, naphthalimide, etc., by removing one or more hydrogen. Other exemplary cyclic imide groups include succinimido, phthalimido, etc.

By “heterocyclyl” is meant a 3-, 4-, 5-, 6- or 7-membered ring (e.g., a 5-, 6- or 7-membered ring), unless otherwise specified, containing one, two, three, or four non-carbon heteroatoms (e.g., independently selected from the group consisting of nitrogen, oxygen, phosphorous, sulfur, selenium, or halo). The 3-membered ring has zero to one double bonds, the 4- and 5-membered ring has zero to two double bonds, and the 6- and 7-membered rings have zero to three double bonds. The term “heterocyclyl” also includes bicyclic, tricyclic and tetracyclic groups in which any of the above heterocyclic rings is fused to one, two, or three rings.

By “hydroxyl” is meant —OH.

By “nitro” is meant an —NO₂ group.

By “oxo” is meant an ═O group.

By “thio” is meant an —S— group.

### Organic Phase

The organic matrix contains one or more types of polymers and may also be referred to as a polymer matrix or polymer binder. In some embodiments, the organic matrix may contain individual polymer chains without significant or any cross-linking between the polymer chains. In some embodiments, the organic matrix may be or include a polymer network characterized by nodes connecting polymer chains. These nodes may be formed by cross-linking during polymerization. The organic matrix is formed by polymerization of a precursor in situ in a mixture with the inorganic ionically conductive particles. The polymers of the organic matrix may be characterized by a backbone and one or more functional groups.

The organic matrix polymers have polymer backbones that are non-volatile. The polymer binder is a high molecular weight polymer or a mixture of different high molecular weight polymers. High molecular weight refers to molecular weight of at least 30 kg/mol, and may be at least 50 kg/mol, or at least 100 kg/mol. The molecular weight distribution can be monomodal, bimodal, and/or multimodal.

A polymer, or polymer binder, has a backbone that may be functionalized. In some embodiments, the polymer backbone is relatively non-polar. Examples include copolymers (block, gradient, random, etc.) such as styrene-butadiene-styrene (SBS), styrene-isoprene-styrene (SIS), styrene-ethylene/propylene-styrene (SEPS), styrene-ethylene-butylene-styrene (SEBS), styrene butadiene rubber (SBR), ethylene propylene diene monomer (EPDM) rubber, and homopolymers such as polybutadiene (PBD), polyethylene (PE), polypropylene (PP), and polystyrene (PS). In some embodiments, the polymer is relatively polar with examples including acrylonitrile-butadiene-styrene (ABS), nitrile rubber (NBR), ethylene vinyl acetate (EVA) copolymers, oxidized polyethylene. Additional examples include fluorinated polymers such as PVDF, polytetrafluoroethylene, and perfluoropolyether (PFPE) and silicones such polydimethylsiloxane (PDMS).

The polymer can be formed from any useful monomer or combination of monomers. In some embodiments, the monomer can be an optionally substituted styrene monomer, an optionally substituted ethylene monomer, an optionally substituted propylene monomer, an optionally substituted butylene monomer, an optionally substituted butadiene monomer, an optionally substituted perfluoroalkane monomer, an optionally substituted perfluoroether monomer, an optionally substituted isoprene monomer, an optionally substituted ethylidene norbornene monomer, or an optionally substituted diene monomer.

In embodiments in which the binder is a copolymer, the constituent polymers may be distributed in any appropriate manner such that the binder can be a block copolymer, a random copolymer, a statistical copolymer, a graft copolymer, etc. The polymer backbone may be linear or non-linear with examples including branched, star, comb, and bottlebrush polymers. Further, transitions between constituent polymers of a copolymer can be sharp, tapered, or random.

The presence of the organic matrix in a relatively high amount (e.g., 2.5-60 wt. % of the solid composites) can provide a composite material having desirable mechanical properties. According to various embodiments, the composite is soft and can be processed to a variety of shapes. In addition, the organic matrix may also fill voids in the composite, resulting in the dense material.

The organic matrix may also contain functional groups that enable the formation of polymerization in an in situ polymerization reaction described below. Examples of end groups include cyano, thiol, amide, amino, sulfonic acid, epoxy, carboxyl, or hydroxyl groups. The end groups may also have surface interactions with the particles of the inorganic phase. Additional functional groups are discussed below.

### Polymer Precursors and In Situ Byproduct Free Polymerization

According to various embodiments, in situ polymerization is performed by mixing ionically conductive particles, polymer precursors and any initiators, catalysts, cross-linking agents, and other additives if present, and then initializing polymerization. This may be in solution or hot-pressed. The polymerization may be initiated and carried out under applied pressure to establish intimate particle-to-particle contact. However, some in situ polymerization processes may form byproducts that can lead to possible increases in the polarization, and thus decreased performance and life-time of cells.

The polymer precursors may be small molecule monomers, oligomers, polymers, or binders. The polymerization reaction may form individual polymer chains from the precursors (or form longer polymer chains from polymeric precursors) and/or introduce cross-links between polymer chains to form a polymer network. A polymer precursor may include functional groups the nature of which depends on the polymerization method employed.

The polymer precursor may be any of the above polymer backbones described above (e.g., polysiloxanes, polyvinyls, polyolefins, polytetrahydrofurans, PFPEs, cyclic olefin polymers (COPs), or cyclic olefin copolymers (COCs), or other non-polar or low-polar polymers) or constituent monomers or oligomers thereof. Depending on the polymerization method, the polymer precursor may be a terminal- and/or backbone-functionalized polymer.

The reactivity of ionically conductive inorganic particles (and sulfide glasses in particular) presents challenges for in situ polymerization. The polymerization reaction should be one that does not degrade the sulfide glass or other type of particle and does not lead to uncontrolled or pre-mature polymerization of the organic components. In particular, glass sulfides are sensitive to polar solvents and organic molecules, which can cause degradation or crystallization, the latter of which may result in a significant decrease in ionic conductivity. Methods employing metal catalysts are also incompatible with sulfide-based ionic conductors. The high content of the sulfur may result in catalyst poisoning, preventing polymerization. As such, methods such as platinum-mediated hydrosilation used for silicon rubber formation, may not be used.

Byproduct-free reactions are a type of process that form a main product without the formation of secondary byproducts. These are desirable processes due to their economical and performance benefits. Processes that do not require dealing with byproducts are more cost-efficient, as no purification or additional processing steps related to byproduct removal is required. In addition, even after extensive purification, secondary products may remain, acting as impurities and leading to reduced performance or even failure of the material.

A byproduct-free reaction is any process that can be described by the following reaction scheme:

A+B→C

There is an extensive number of chemicals reactions that are byproduct-free, including varieties of Michael addition or ring-opening methods. Epoxy resins, radical and polyurethane syntheses are just a few out of many byproduct-free polymerization approaches. Exemplary Michael addition reactions include a reaction between a nucleophile (e.g., a carbanion or other nucleophile) and an α,β-unsaturated carbonyl compound; and exemplary a ring opening reaction with a nucleophile and a strained heterocyclyl electrophile (e.g., a cyclic ether, a cyclic carbonate, a cyclic cycloalkene, a cyclic trisiloxane, a lactone, a lactide, etc.).

Some polymerization techniques do not generate byproducts, including Diels-Alder and ‘click’ chemistry approaches. These types of reactions can lead to desirable mechanical properties of organic or hybrid matrices that still allow for the use of low-pressure processing tooling, offering a wide selection of monomers and compositions. In addition, some polymeric materials generated through these approaches present self-healing properties to auto-repair physical damage under heat treatment, and thus may increase the safety index and service lifetime of batteries into which they are incorporated.

In some embodiments, polymer precursors are functionalized with functional groups to allow for byproduct-free reactions. The functional groups can be incorporated during polymerization step and/or in a post-polymerization functionalization step. Polymers can also be prepared with one or multiple types of functional groups, depending on targeted features of the binder. The properties include but are not limited to: solubility in organic solvents, adhesion to inorganic particles, adhesion to current collectors, dispersibility of inorganics, mechanical performance, ionic conductivity, electrochemical and chemical stabilities, and electronic conductivity.

Yet other click chemistry reactions can be described by a reaction between a pair of two reactive groups (e.g., two click-chemistry groups). Exemplary pairs include a Huisgen 1,3-dipolar cycloaddition reaction between an alkynyl group and an azido group to form a triazole-containing linker; a Diels-Alder reaction between a diene having a 4π electron system (e.g., an optionally substituted 1,3-unsaturated compound, such as optionally substituted 1,3-butadiene, 1-methoxy-3-trimethylsilyloxy-1,3-butadiene, cyclopentadiene, cyclohexadiene, or furan) and a dienophile or heterodienophile having a 2π electron system (e.g., an optionally substituted alkenyl group or an optionally substituted alkynyl group); a ring opening reaction with a nucleophile and a strained heterocyclyl electrophile; a thiol and an optionally substituted alkyne; and a splint ligation reaction with a phosphorothioate group and an iodo group; a nucleophile and an optionally substituted α,β-unsaturated carbonyl compound; a nucleophile and an optionally substituted strained cyclic compound; and a reductive amination reaction with an aldehyde group and an amino group.

Exemplary and non-limiting reactive groups include an optionally substituted 1,3-butadiene, an optionally substituted alkene, optionally substituted alkyne, an optionally substituted α,β-unsaturated aldehyde, an optionally substituted unsaturated α,β-thioaldehyde, an optionally substituted α,β-unsaturated ketone, an optionally substituted azide, an optionally substituted thiol, an optionally substituted unsaturated cycloalkyl, an optionally substituted unsaturated heterocycle, an optionally substituted α,β-unsaturated imine, an optionally substituted aldehyde, an optionally substituted imine, an optionally substituted nitroso-compound, an optionally substituted diazene, an optionally substituted thioketone, an optionally substituted α,β-unsaturated ketone, an optionally substituted α,β-unsaturated aldehyde, an optionally substituted anionic nucleophile, and an optionally substituted strained epoxy. Optional substituents can be any described herein (e.g., for alkyl or aryl).

### Byproduct-Free Approaches

Diels-Alder Reactions

In some embodiments, the polymer matrix is formed by a Diels-Alder reaction. The Diels-Alder reaction is a method for preparation of six-membered rings. It may also be known as a [4+2] cycloaddition reaction. The process occurs between a conjugated diene and an alkene or alkyne, known as a dienophile. Diels-Alder cycloaddition may be divided into two sub-groups. One sub-group is normal electron demand Diels-Alder (DA) (Scheme 1A), in which a diene is electron rich and dienophile is electron poor. In the second sub-group, the inverse electron demand Diels-Alder (rDA) (Scheme 1B), the roles are reversed, and a diene is more electron poor than a dienophile. In some embodiments, the polymer precursors include at least one functional group that is a diene, and at least one functional group that is a dienophile.

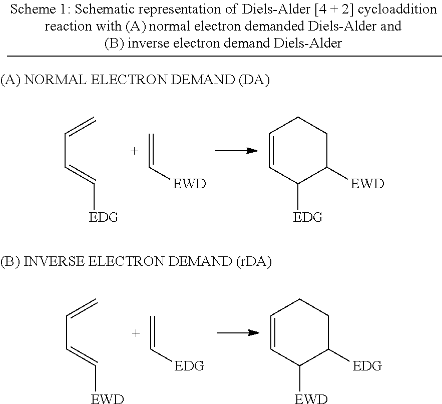

The chemical structure of the diene and dienophile determines how easily the reaction occurs. For instance, a reaction between unsubstituted reagents (G₁=H, G₂=H; where G₁=diene, G₂=dienophile), butadiene and ethylene, requires temperatures as high as 700° C. to form cyclohexene. The Diels-Alder reaction, however, can be controlled by tuning the properties/structure of the diene or/and dienophile. In some embodiments involving a normal electron demand DA reaction, electron withdrawing (EWD) substituent(s) can be introduced into the dienophile (G₂=EWD), which may speed up the reaction; the more electron-poor the dienophile, the easier the reaction occurs. As an example, introducing one nitrile group into ethylene can reduce the reaction temperature from 700° C. to 140° C. (Scheme 2A), and drop further to 20° C. when three more nitrile functionalities are added (Scheme 2B).

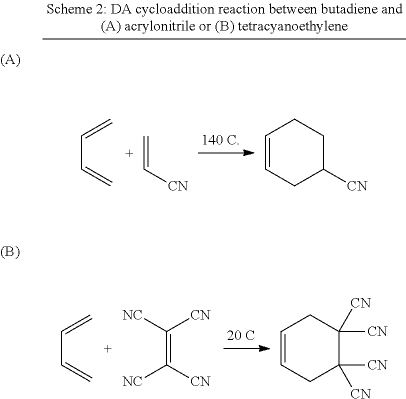

In some embodiments, a diene functional group may include at least one EWD substituent, for example: —SO₂CF₃ (triflates), —CF₃, —CCl₃ (trihalides), —CN (nitriles), —SO₃R (sulfonates, e.g., in which R can be H, optionally substituted alkyl, or optionally substituted aryl, as defined herein), —N₀₂ (nitro), —NR₃⁺ (ammonium salts, e.g., in which R can be H, optionally substituted alkyl, or optionally substituted aryl, as defined herein), —CHO (aldehydes), —COR (ketones e.g., in which R can be optionally substituted alkyl or optionally substituted aryl, as defined herein), —COOH (acids), —COCl (acyl chloride), —COOR (esters, e.g., in which R can be optionally substituted alkyl or optionally substituted aryl, as defined herein), —CONR₂ (amides, e.g., in which R can be H, optionally substituted alkyl, or optionally substituted aryl, as defined herein), or —X (halides, such as —Cl, —F, —Br, —I).

A similar activating effect for the normal electron demand DA reaction can be achieved with electron donating (EDG) substituents located at the diene reactant. In some embodiments involving a normal electron demand DA reaction, electron donating (EDG) substituents can be introduced into the diene (G₁=EDG), which may speed up the reaction; the more electron-rich the diene, the easier the reaction occurs. In the example below, a more reactive 1-methoxy-1,3-butadiene reacted with acrolein (Scheme 3B) at 100° C. as compared to the reaction with butadiene that required 160° C. (Scheme 3A). In some embodiments, a diene functional group may include at least one EDG substituent, for example, in decreasing order of electron donating strength: —OAr (aromatic oxides, e.g., in which Ar can be optionally substituted aryl, as defined herein), —NR₂ (primary, secondary and tertiary amines, e.g., in which each R is, independently, H or optionally substituted alkyl, as defined herein), —OR (ethers, e.g., in which R is optionally substituted alkyl or optionally substituted aryl, as defined herein), —ArOH (aromatic alcohols, e.g., in which Ar is optionally substituted aryl or optionally substituted arylene, as defined herein), —NHCOR (amides, e.g., in which R is optionally substituted alkyl or optionally substituted aryl, as defined herein), —OCOR (esters, e.g., in which R is optionally substituted alkyl or optionally substituted aryl, as defined herein), —R (alkyl, e.g., in which R is optionally substituted alkyl, as defined herein), —Ar (aromatic, e.g., in which Ar is optionally substituted aryl, as defined herein), or —CH═CH₂ (vinyl).

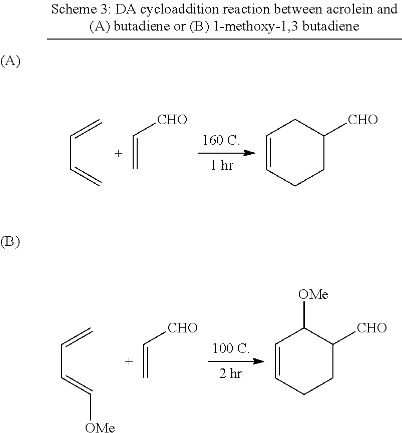

In some embodiments, an inverse electron demand rDA reaction occurs during polymerization. For the inverse electron demand rDA reaction, one process involves a cycloaddition between an electron-rich dienophile (containing EDG functionality) and an electron-poor diene (containing EWD group). Generally, the EWD and EDG substituents described above may be used for an rDA reaction (G₁=EWD, G₂=EDG). In such embodiments, a diene functional group may include at least one EDG substituent, and/or a dienophile functional group may include at least one EWD substituent. This approach may be useful for synthesizing heterocyclic compounds, for instance pyrans, piperidines, and their derivatives.

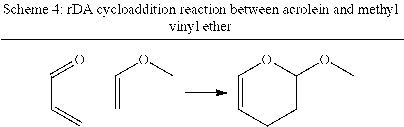

In some embodiments, normal electron demand Diels-Alder can be catalyzed by Lewis acids, such as metal chlorides, e.g., tin chloride, zinc chloride, or boron trifluoride. Binding of a catalyst to a dienophile increases its electrophilicity, and hence reactivity, thus reducing thermal reaction requirements.

One benefit of a DA reaction is that it may be thermally reversible. A retro DA reaction is a process where a six-membered ring reacts to form a diene and a dienophile, and is typically accomplished by a thermal treatment. Some retro DA reactions may also be facilitated by chemical activation, such as with Lewis acid or base mediation. The thermal reversibility of some DA reactions enables self-healing properties, as heating the polymer dissociates the DA cross-links, which may then reform upon subsequent cooling. In some embodiments, the polymer precursors are functionalized with groups that may undergo retro DA as well as either normal DA or reverse rDA.

1+3-Dipole Cycloaddition ‘Click’ Reactions

In some embodiments, the polymer matrix may be formed by a [1+3] Dipole cycloaddition reaction. The [1+3] dipolar cycloaddition is a method of preparation for five-membered rings via a reaction of a 1,3-dipole and a dipolarophile. One example is a [3+2]cycloaddition between azides and alkynes, also known as Huisgen cycloaddition, that generates 1,2,3-triazoles (Scheme 5).

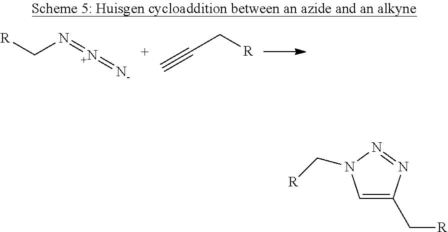

In some embodiments, 1,3-dipoles are allyl or propargyl/allenyl type zwitterions, such as azomethine ylides and imines, nitrones, nitro compounds, carbonyl oxides and imides, carbonyl ylides and imines, azides, diazoalkanes, thiosulfines, etc. In some embodiments, dipolarophiles may be various alkenes and alkynes as well as carbonyls and imines. In some embodiments, a metal catalyst may be used, such as a copper-based catalyst, to increase the reaction kinetics. In some embodiments, the reaction kinetics may also be improved in the presence of strained dipolarophiles, such as cyclooctyne and its analogs and substituted derivates. In some embodiments, strain-promoted cycloaddition reactions may occur spontaneously without a catalyst.

Thiol-Ene ‘Click’ Reactions

In some embodiments, the polymer matrix may be formed by a thiol-ene ‘click’ reaction between thiols and alkenes or alkynes (Scheme 6) to form sulfides. The process may occur via free-radical mechanism, catalyzed by radical initiators, UV-light or temperature, or Michael addition, and accelerated by bases and nucleophiles. A thiol-ene ‘click’ approach can be a very efficient reaction that proceeds with high yields, making it an attractive synthetic tool for various applications.

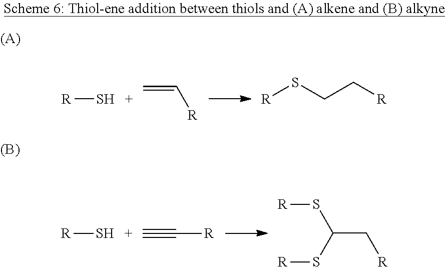

Scheme 7 shows examples of various thiol-ene reactions that may occur in various embodiments. Thiols are reactive with many alkenes and alkynes. For instance, polybutadiene can be ‘in situ’ cross-linked’ with different dithiols, using temperature, UV-light or a radical initiator as reaction promotors, to form a cross-linked network (Scheme 7A). The process resembles the vulcanization of rubber, but is more efficient and requires milder conditions than traditional methods with sulfur. In addition, the wide availability of reactive groups makes the post-modification of polymer precursors in preparation for thiol-ene click reactions easy. For instance, hydroxyl end groups in hydrogenated polybutadiene can be transformed into thiol-reactive acrylate groups, which can further be reacted with thiol cross-linkers to form a cross-linked network (Scheme 7B). Furthermore, thiol-ene reactions may be used to control the functionalization of unsaturated polymers. The wide availability of various thiol reagents and high efficiency of the reaction makes ‘thiol-ene’ processes an excellent choice of controlled functionalization of polymers, such as polybutadiene (Scheme 7C) or poly(styrene-b-butadiene) rubber.

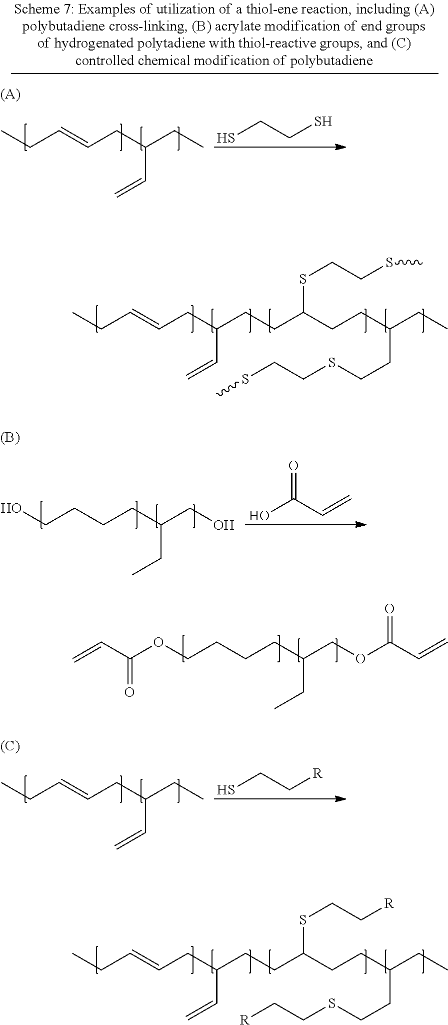

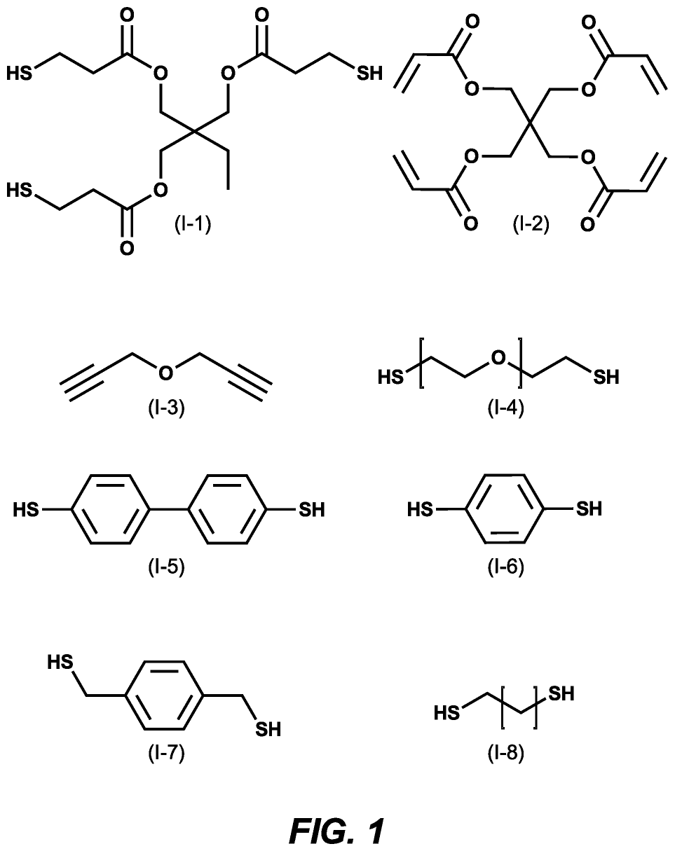

FIG. 1 shows representative examples of commercially available thiols and alkene/alkyne cross-linkers that can be useful in thiol-ene based polymerization/cross-linking. In some embodiments, at least some polymer precursors may include or be functionalized with at least one thiol group and/or at least one alkene/alkyne. Non-limiting compounds can include compounds (I-1) to (I-8) in FIG. 1, in which the ethylene oxide group in compound (I-4) can be any useful number n (e.g., 1, 2, 3, 4, 5, 6, 7, 8, 9, 10, or more) and in which the methylene group in compound (I-8) can be any useful number n (e.g., 1, 2, 3, 4, 5, 6, 7, 8, 9, 10, or more).

### Diels-Alder Approach in Hybrid Electrolytes

The Diels-Alder functionality can be located on either binder or small molecule additives of polymer precursors. A functionality (f) of 2 leads to linear polymers, whereas f≥3 allows for crosslinked polymers. In some embodiments, at least one polymer precursor bears a diene group, and at least one polymer precursor bears a dienophile group. Generally, polymer precursors may carry at least one type of dienophile or diene group per molecule, or both functionalities.

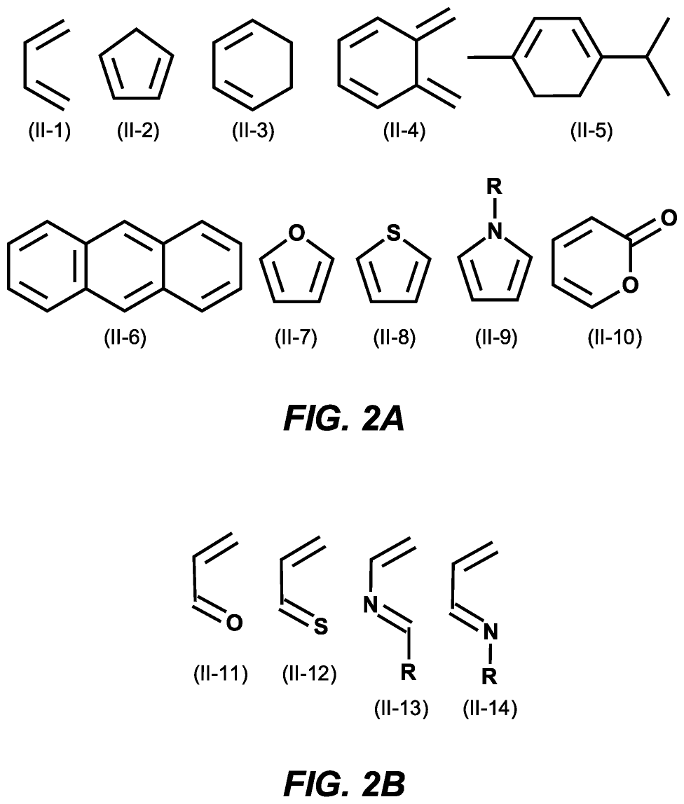

In some embodiments, the diene group may include any conjugated dienes in cis configuration. Dienes may be separated into two main groups, all-carbon (FIG. 2A) and heteroatom-based (FIG. 2B). All-carbon dienes contain unsaturated conjugated chain made only of carbon atoms, that includes linear and cyclic dienes, such as butadiene, cyclopentadiene, anthracene, α-terpinene, furan, thiofuran, etc. Yet other examples include compounds (II-1) to (II-10) in FIG. 2A, in which R can be H, optionally substituted alkyl, or optionally substituted aryl, as described herein.

Heteroatom-based dienes may include at least one heteroatom, such as O, N, S, in a conjugated diene structure. Examples of heteroatom dienes include α,β-unsaturated aldehydes and ketones, and imines, for instance, acrolein, and thioacrolein. Yet other examples include compounds (II-11) to (II-14) in FIG. 2B, in which R can be H, optionally substituted alkyl, or optionally substituted aryl, as described herein.

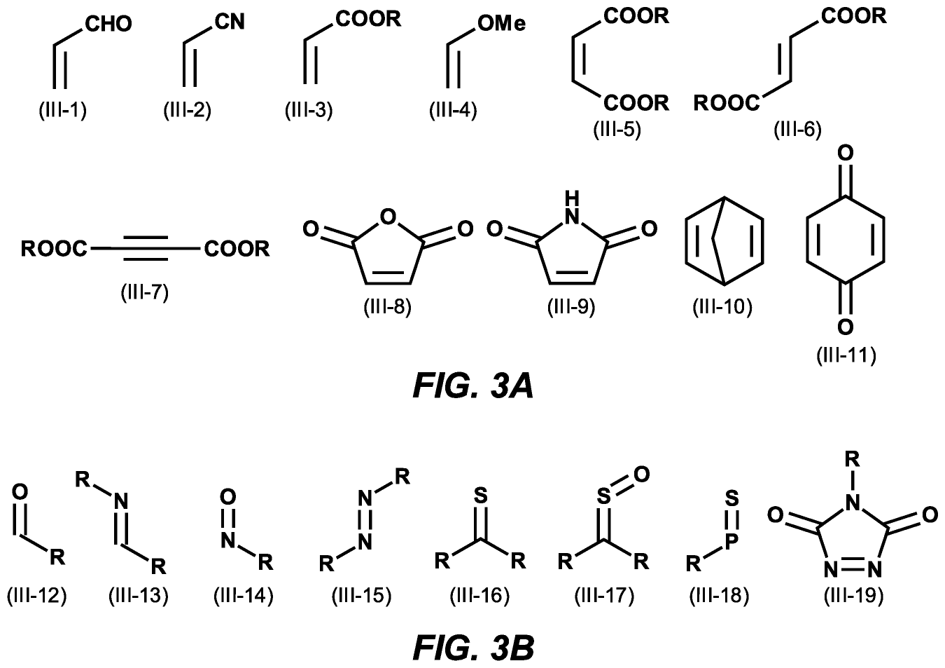

Similarly to dienes, dienophiles group can be divided into all-carbon (FIG. 3A) and heteroatom-based (FIG. 3B) dienophiles. All-carbon dienophiles include varieties of alkene and alkyne-based compounds, for instance, acrolein, acrylonitrile, fumarates, maleates, maleic anhydrides, and imides. Yet other examples include compounds (III-1) to (III-11) in FIG. 3A, in which R can be H, optionally substituted alkyl, or optionally substituted aryl, as described herein.

Dienophiles with heteroatoms in reactive groups include aldehydes, imines, nitroso-compounds, diazenes, and thioketones. Yet other examples include compounds (III-12) to (III-19) in FIG. 3B, in which R can be H, optionally substituted alkyl, or optionally substituted aryl, as described herein.

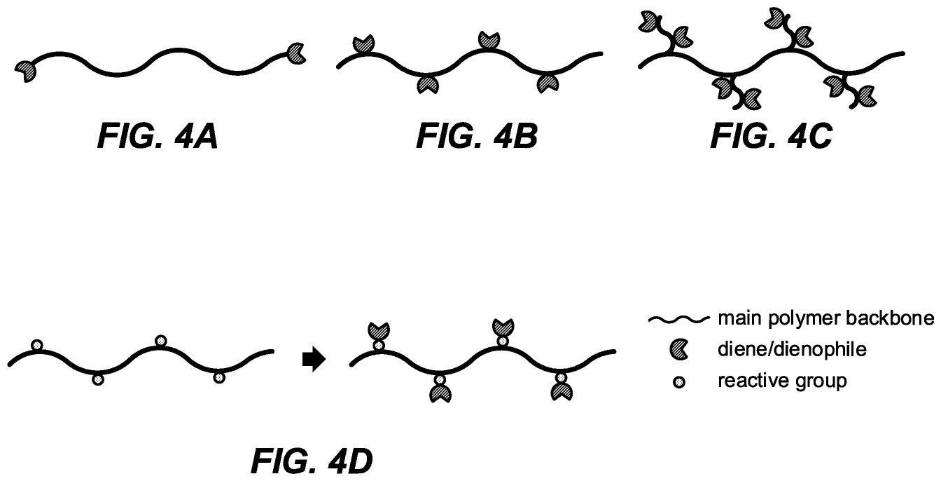

In some embodiments, DA-reactive polymers are modified with functional groups, e.g., dienes or dienophiles, in different concentrations, using either a direct or indirect process. FIG. 4 provides examples of various functionalized polymers. Copolymerization of DA inert monomers with DA-reactive monomers or macromonomers can respectively lead to functionalized copolymers (FIG. 4B) and graft copolymers (FIG. 4C). In embodiments using the indirect approach, a polymer can be functionalized with DA groups in a post-functionalization processing that may involve modification of specific groups, for instance end groups (FIG. 4A) or functional monomers (FIG. 4D).

Scheme 8 shows some examples of reactions that can be employed in post-functionalization of different polymers with furfuryl groups in some embodiments. For instance, hydroxyl end groups of polybutadiene can be modified via reaction of isocyanate to form urethane bond (Scheme 8A), maleic anhydride copolymerized with ethylene can be reacted with amine to form cyclic amides (Scheme 8B) and unsaturated bonds in polybutadiene can be reacted with mercaptanes in thiol-ene reaction (Scheme 8C).

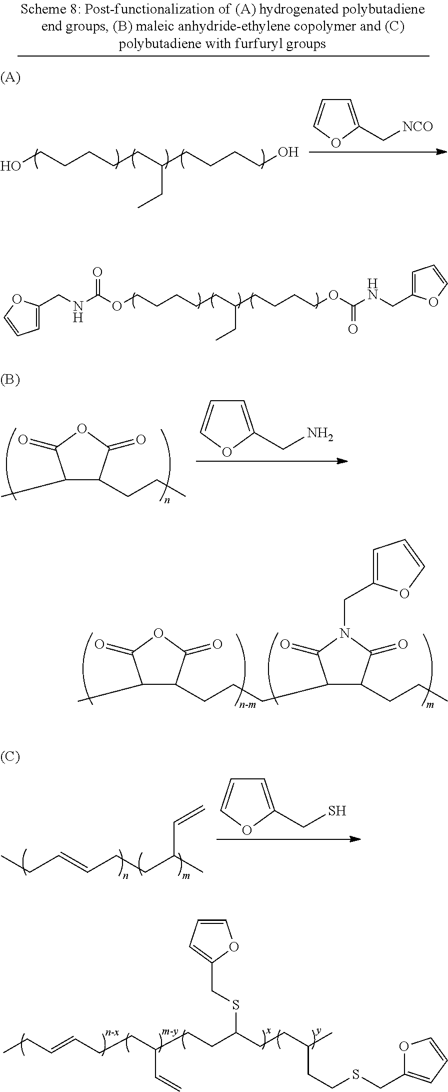

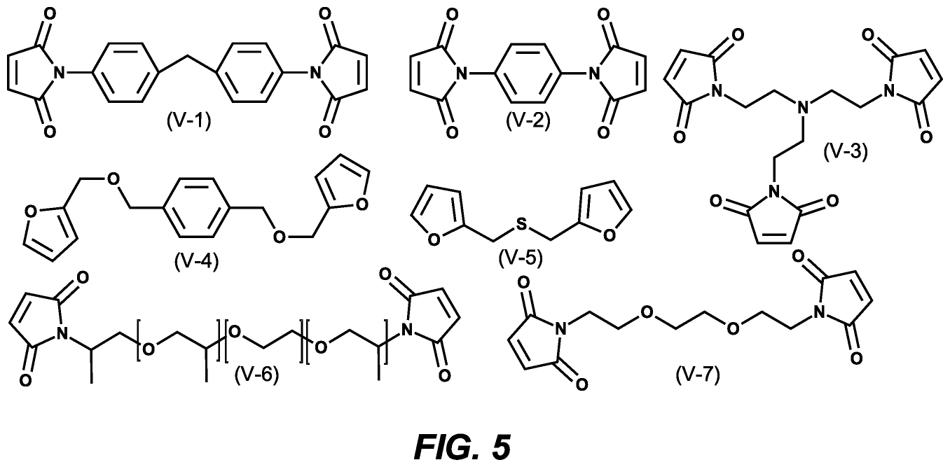

In some embodiments, besides functional polymers, the organic matrix may contain small molecule monomers and cross-linkers. FIG. 5 shows some examples of small molecule diene and dienophile monomers and cross-linkers. In some embodiments, the organic matrix may also contain polymeric cross-linkers and monomers as shown on FIG. 5, such as compounds (V-1) to (V-7), in which the ethylene oxide group or propylene oxide group in compound (V-6) can be any useful number n (e.g., 1, 2, 3, 4, 5, 6, 7, 8, 9, 10, or more).

### EXAMPLES

### Example 1: Diels-Alder Cross-Linked SEBS Films

Thermoplastic elastomers, such as SEBS, SBS or SIS, may be used as binders for generation of all-solid-state thin film electrolytes. The low polarity and hydrophobic character of such binders allow for a high retention of initial conductivity of pure inorganic conductors, such as lithium phosphorous sulfide (LPS) glasses, while its blocks-based structure provides good mechanical properties to the hybrid electrolyte generated in the process. However, such binders are thermoplasts based, which means that they form a physically crosslinked-network, bound by non-covalent interactions.

A solid binder was modified with furfuryl groups to enable DA crosslinking in the presence of small molecule bismaleimide. DA crosslinking of SEBS enabled incorporating covalent crosslinks into the physically cross-linked network formed by the binder, thus improving its mechanical strength and making it resistant to dissolution in good solvents.

SEBS was doped with 2 wt. % of maleic anhydride (SEBS-gMA) in the soft block and reacted with furfuryl amine. SEBS-gFA was synthesized by reacting SEBS-gMA with an excess of furfuryl amine, as shown in Scheme 9.1.

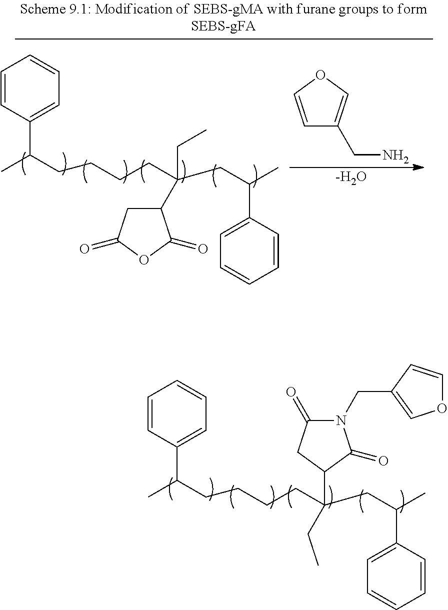

In a glove box operated under nitrogen, 30.0 g (6.1 mmol of maleic anhydride) of polystyrene-b-poly(ethylene-ran-butylene)-b-polystyrene-g-maleic anhydride (SEBS-gMA, Sigma-Aldrich) and 250 g of dry toluene were placed in a 500 ml pressure vessel that was previously dried at 145° C. The vessel was sealed, and the mixture was stirred on a hot-plate at 60° C. until the polymer fully dissolved. Next, the vessel was brought back into the glove box and cooled to room temperature before adding 2.4 g (24.7 mmol) of furfurylamine to the mixture. The reaction was then further stirred at 60° C. for 18 hours (hrs). Afterwards, the reaction mixture was precipitated into methanol, solids were re-dissolved in dichloromethane, and then precipitated again into methanol. This process was repeated two more times to obtain the furfuryl-modified SEBS (SEBS-gFA) as a white solid. The SEBS-gFA was then dried under vacuum at 100° C. for 16 hrs.

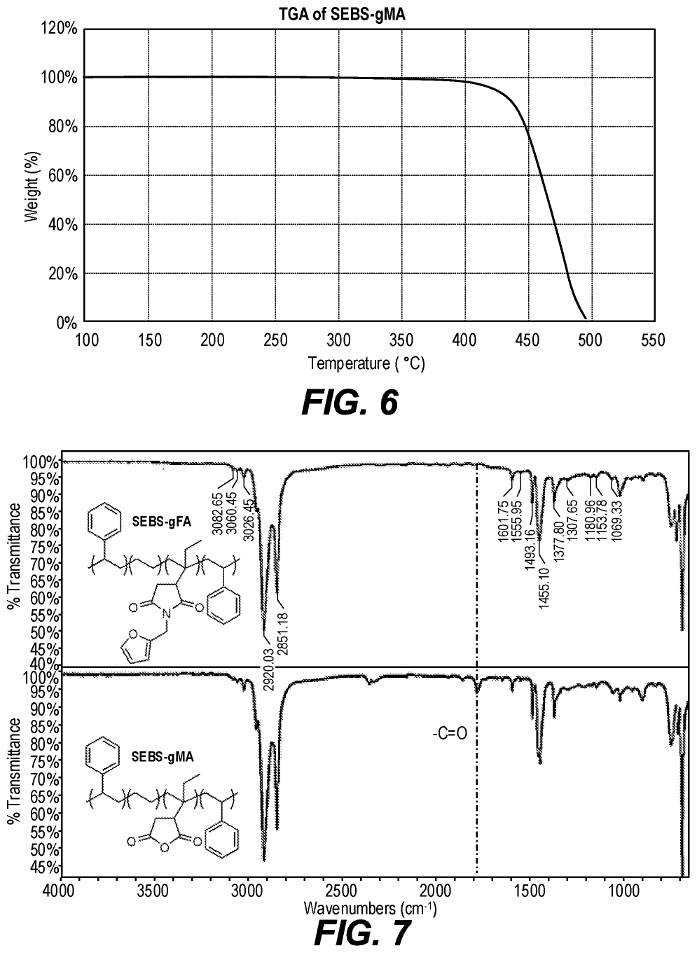

Thermal stability and purity of SEBS-gMA was tested using thermogravimetric analysis. SEBS-gMA was heated under nitrogen to 500° C., showing practically no weight loss up to ˜370° C., proving high thermal stability of the polymer as well as no significant volatile impurities or moisture content (see FIG. 6).

FTIR spectra of SEBS-gMA and SEBS-gFA are shown in FIG. 7. A high concentration of overlapping signals related to the SEBS-backbone causes the spectra to look alike. A major difference between the spectra is the disappearance of the carbonyl (—C═O) stretch, ˜1790 cm⁻¹, related to the maleic anhydride ring in SEBS-gMA. The lack of visible —C═O stretch in SEBS-gFA might be related to the weaker intensity of the carbonyl signal in maleimide ring versus anhydride, which at such low concentrations might be difficult to spot.

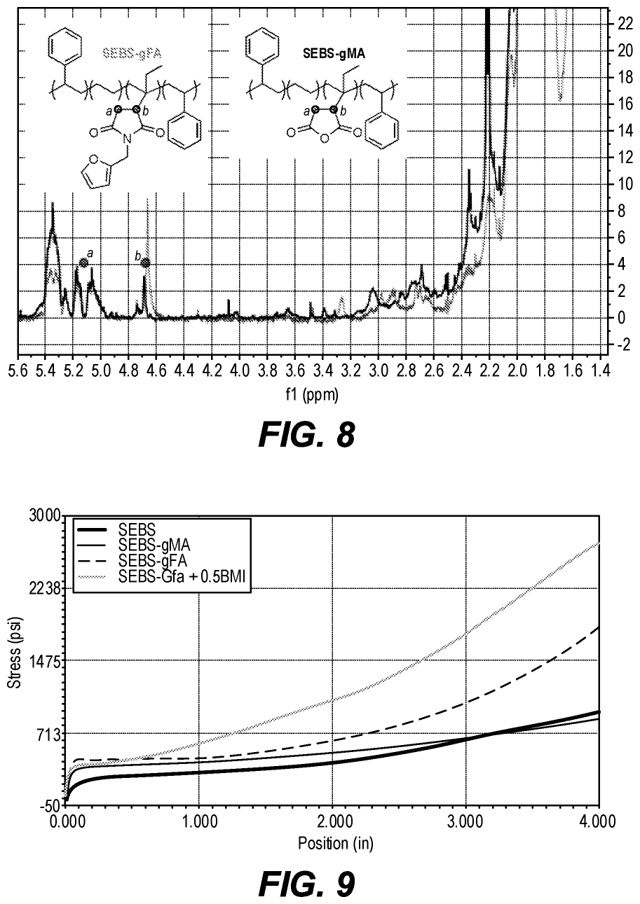

Proton nuclear magnetic resonance (¹H NMR) analyses of the starting materials, SEBS-gMA, and the product, SEBS-gFA, were done using a 700 MHz instrument as shown in FIG. 8. Due to the low concentration of functional groups in SEBS-gMA (2 wt. %) and SEBS-gFA (3.5 wt. %), a quantitative analysis of spectra was not possible. However, the qualitative analysis of the signals corresponding to functional groups in the product and starting materials showed a shift of peaks and change in their intensity. FIG. 8 shows an overlay of SEBS-gMA (black) and SEBS-gFA (gray) spectra in a region having characteristic peaks corresponding to cyclic rings of maleic anhydride and maleimide.

Next, SEBS-gFA was tested in a Diels-Alder crosslinking process with 1,1′-(methylenedi-4,1-phenylene)bismaleimide (BMI). A solution of SEBS-gFA in toluene was mixed with BMI in 2:1 ratio of furfuryl to maleimide groups. A 20 mL vial equipped with a stir bar was charged with 1.50 g (0.037 mmol of furfuryl groups) of SEBS-gFA, 27.0 mg (0.075 mmol) of BMI, and 3.0 g of 1,2,4-trimethylbenzene. The mixture was stirred at 40° C. until dissolution of all components, then cooled to room temperature. Next, the solution was cast on Mylar using a doctor blade, and the thin film was air-dried before being transferred to the vacuum oven and heated at 100° C. for 12 h. The film was cut into three pieces and one of them were additionally heated for 5 hr at 120° C. Films were cooled down to room temperature before peeling off the substrate (Scheme 9.2).

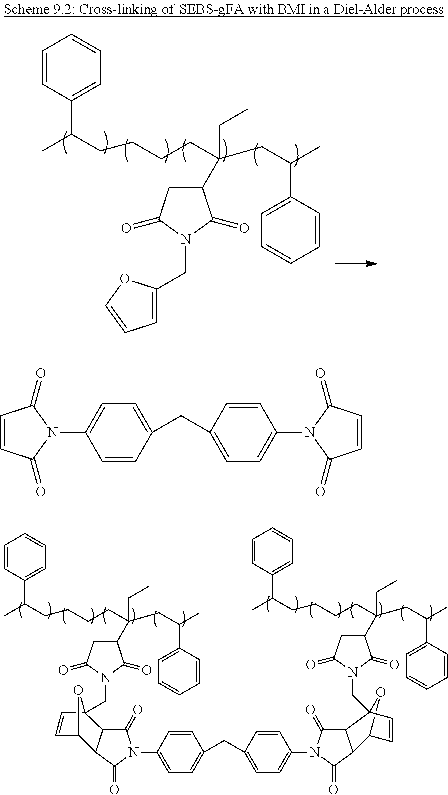

Tensile testing of the crosslinked film was performed to determine the elastic modulus, tensile strength, and elongation at break. The properties of the SEBS-gFA+0.5BMI film were measured against properties of pure SEBS (not-functionalized), SEBS-gMA and SEBS-gFA films processed under the same conditions. All films were cut into 8 mm×50 mm strips and at least three measurements per film were performed using a mini tensile tester. Due to the short grip separation of the instrument, the tensile strength and elongation at break could not be measured as the limit of the instrument was reached before the failure of the materials occurred. Each of the polymer films was very elastic, reaching >800% elongation. FIG. 9 shows representative curves obtained in stress-strain tests for SEBS (thick black line), SEBS-gMA (thin black line), SEBS-gFA (dashed line), and SEBS-gFA+0.5BMI (gray line) films tested at 0.05 in/min rate. Table 1 summarizes elastic moduli from stress-strain curves for SEBS, SEBS-gMA, SEBS-gFA, and Diels-Alder crosslinked SEBS-gFA+0.5BMI films.

TABLE 1
Elastic moduli of different polymer films

| | | | | SEBS-gFA + |
|---|---|---|---|---|
| | SEBS | SEBS-gMA | SEBS-gFA | 0.5 BMI |
| E/MPa | 12.07 ± 0.14 | 20.82 ± 2.96 | 26.82 ± 1.65 | 28.54 ± 2.07 |

Elastic moduli measured for SEBS, SEBS-gMA, SEBS-gFA, and crosslinked SEBS-gFA+0.5BMI vary significantly from each other, providing evidence of the importance of the overall composition and type of functional group. Adding 2 wt. % of polar maleic anhydride grafts to SEBS composition drastically improved the modulus of the binder, showing over 70% higher value (20.82 MPa) than SEBS hybrid. Further modification of SEBS-gMA with furfuryl groups resulted in even more polar SEBS-gFA binder, and even higher modulus of 26.82 MPa. Finally, when SEBS-gFA was crosslinked with BMI, the film showed modulus of 28.54 MPa, proving that the Diels-Alder reaction occurred, and that the additional covalent crosslinks formed in the process increased the overall toughness of the polymer film.

### Example 2: Hybrid Electrolytes with Diels-Alder Crosslinking

After testing mechanical properties of pure SEBS, SEBS-gMA, SEBS-gFA and BMI-crosslinked SEBS-gFA films, the polymers were incorporated into composite electrolytes. Each polymer was tested as a binder in hybrids prepared with 80 wt. % of 75:25=Li₂S:P₂S₅ sulfide glass. Composites were prepared as thin films via slurry casting, dried and hot-pressed at 160° C. Binder structures are provided below for (A) SEBS, (B) SEBS-gMA, (C) SEBS-gFA and (D) BMI-crosslinked SEBS-gFA:

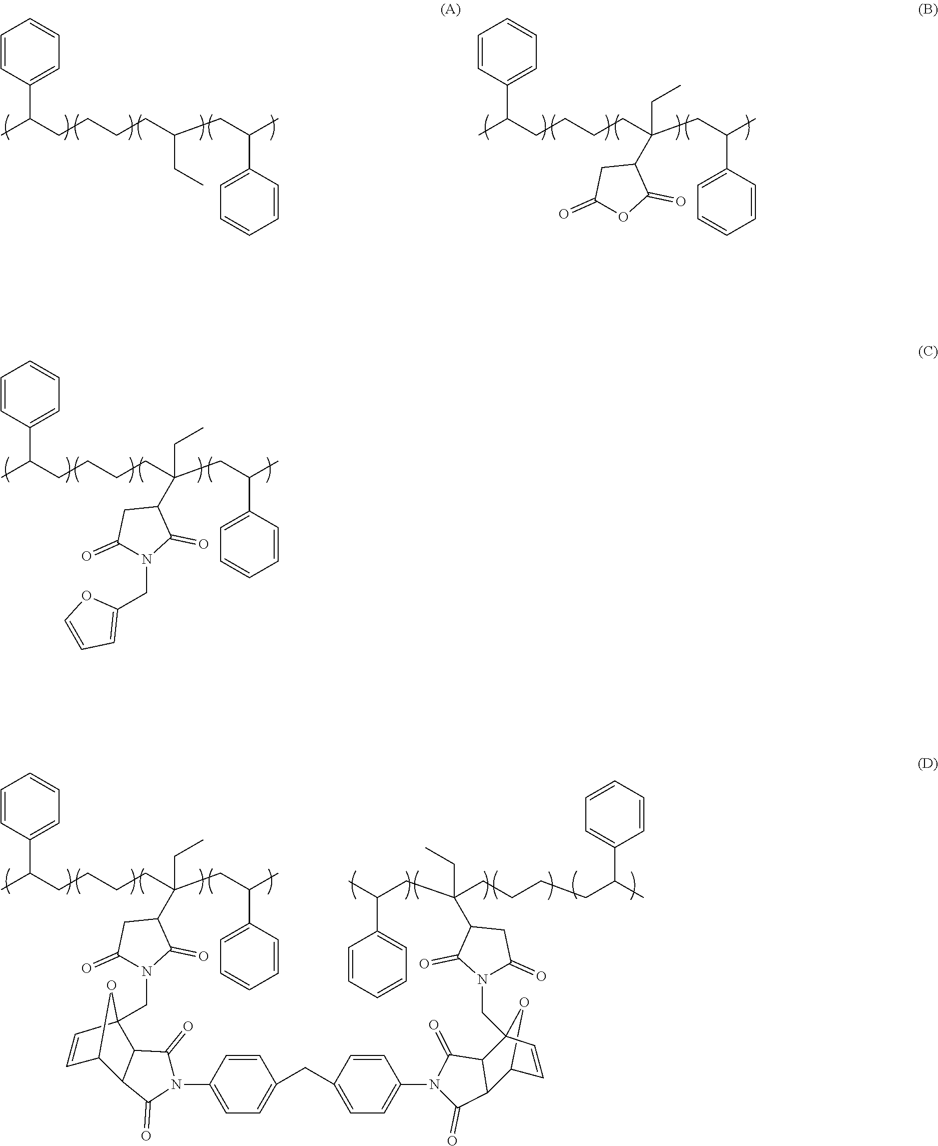

Conductivities of the composites were measured to assess the effect of binder on the conductivity retention of pure 75:25=Li₂S:P₂S₅ sulfide glass. The incorporation of polar groups into a non-polar binder, such as SEBS, had a drastic effect on the conductivity of measured films. When SEBS was used as a binder, the conductivity was ˜0.18 mS/cm, a 33% conductivity retention of the original inorganic materials (˜0.55 mS/cm) (Table 2). When SEBS was modified with small amounts of polar functionalities capable of strong binding to the surface of glass particles, the conductivities dropped nearly an order of magnitude. For SEBS-gMA hybrid, the conductivity was about 8× lower, and for the BMI-crosslinked SEBS-gFA, about 6× lower (Table 2).

When pure SEBS-gFA was used as the organic matrix, the conductivity was only lower by a factor of 2.3×. This suggests that addition of BMI into the system had a large influence on the organic matrix, and hence, on the conductivity of the resulting hybrid. That difference between hybrids containing SEBS-gFA, and SEBS-gFA with BMI cross-linker might be related to the difference in viscosities of the organic matrix in both composites. Higher viscosities of organic matrix may lead to reduced flow of particles during hot-pressing, and thus prevent good particle-to-particle contact that may result in good conductivity performance of electrolyte composites. During casting of hybrids containing SEBS-gFA and BMI it was noticed that the viscosity of the slurry was unusually high and required much higher dilutions to cast a hybrid film. The increase in viscosity was ascribed to the Diels-Alder process occurring in the slurry between furfuryl and maleimide groups. That led to formation of polymers with much higher molecular weight than the starting SEBS-gFA, and hence, higher viscosities and obstructed particles movement during hot-pressing processing.

TABLE 2
Conductivity and mechanical properties measured for hybrids with 80 wt. %
75:25 = Li₂S:P₂S₅ glass and different polymer binders

| | | | Tensile | Elongation | |
|---|---|---|---|---|---|
| Conductor | Polymer | Modulus | strength | at break | Cond. at 25° C. |
| comp. | binder | [GPa] | [MPa] | [%] | [mS · cm⁻¹] |
| Li₂S:P₂S₅ = | SEBS | 0.575 ± 0.116 | 4.24 ± 0.68 | 2.20 ± 0.33 | 0.182 |
| 75:25 | SEBS-gMA | 0.646 ± 0.107 | 5.56 ± 0.08 | 4.47 ± 0.27 | 0.023 |
| (80 wt. %) | SEBS-gFA | 0.606 ± 0.065 | 8.29 ± 0.27 | 17.00 ± 0.30 | 0.078 |
| | SEBS-gFA + | 0.494 ± 0.037 | 6.10 ± 0.21 | 8.67 ± 0.23 | 0.031 |
| | 0.5 BMI | | | | |

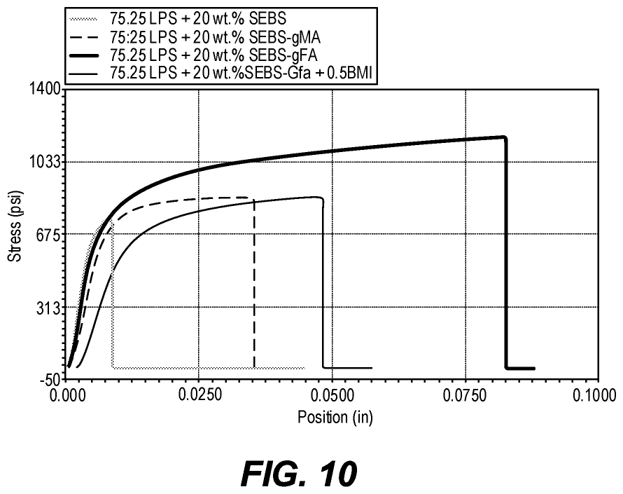

Next, mechanical testing of all hybrids was done to obtain elastic modulus, tensile strength and elongation at break. Mechanical testing was performed under the same conditions as for the pure polymer films. Representative stress-strain curves of each hybrid are shown in FIG. 10; and extracted modulus, tensile strength, and elongation at break values are summarized in Table 2.

Visual comparison of stress-strain curves obtained for hybrids with different binder shows a clear difference in mechanical properties between all of them. There is a trend in increasing tensile strength and elongation at break of hybrids prepared with higher polarity binders. In the case of SEBS hybrids, the samples break at only 2.2% elongation (Table 2). When as little as 2 wt. % of maleic grafts are incorporated into SEBS (SEBS-gMA), the value doubles reaching 4.7%. Further modification with furfuryl groups (SEBS-gFA) increased the wt. % of polar groups to 3.5 wt. %. That modification drastically increased the elongation at break to 17.0%, which is respectively 8.5 and 4 times higher than SEBS and SEBS-gMA. The same trend was observed for tensile strength of films, which showed 4.2, 5.6 and 8.3 MPa values for SEBS, SEBS-gMA and SEBS-gFA binder, respectively, proving improved resistance of films to breakage when more polar binder is incorporated into organic matrix (Table 2).

The properties of BMI-crosslinked SEBS-gFA hybrid were between those of SEBS-gMA and SEBS-gFA hybrids (Table 2), showing that cross-linking caused the decrease in performance of the hybrid in comparison to pure SEBS-gFA. It is speculated that a high loading of inorganic particles may reduce the efficiency of crosslinking between furfuryl and maleimide groups, affecting the mechanical properties. In addition, inefficiency of the Diels-Alder reaction may lead to more partially reacted BMI groups. Hence, instead of forming crosslinks, such groups would act as a bulky, rigid functionalities that might be less efficient in coordinating with the surface of inorganic particles. That may not only affect the mechanical properties of the organic matrix, but also change the adhesion of the binder to inorganic particles, therefore, affecting the mechanical performance of the hybrid film.

### Example 3: Synthesis of Hybrid Electrolytes Based on POSS Nanocomposites

An inorganic-organic hybrid matrix may be based on polyhedral oligomeric silsesquioxane (POSS) compounds, which are organic-inorganic hybrids with the empirical formula Rⁿ(SiO_{1.5})ₙ (n=8, 10, or 12), and have dimensions comparable to polymer segments or coils. The rigid and cubic cage can be considered as the smallest possible particles of silica. Each cage silicon atom is attached to a single R substituent, which can be a reactive or nonreactive organic group (e.g., glycidyl, phenyl, cyclohexyl), or organic-inorganic hybrids (e.g. —OSiMe₂OPh). Reactive organic groups allow for preparing composite materials with the inorganic POSS core molecularly dispersed in the matrix. Compared to polymeric materials, the POSS nanocomposites may have superior properties including higher use temperature, oxidation resistance and improved mechanical properties, as well as lower dielectric constant, flammability and heat evolution.

FG-POSS was synthesized by reacting glycidyl (G) POSS with furfurylamine (F). 12.1 g G-POSS (9.0 mmol, 72.0 mmol epoxy group) was dissolved in 60 ml in dimethylformamide under argon. 8.7 g furfurylamine (89.7 mmol amide group) is added dropwise into the solution. After reaction at 60° C. for 1 day, the unreacted furfurylamine and redundant solvent are removed using a centrifuge (4500 rpm at −4° C.), and a viscous transparent liquid was obtained. A hybrid POSS matrix is obtained by dissolving 5 g FG-POSS in 40 ml anhydrous tetrahydrofuran (THF), followed by the addition of a stoichiometric amount of 1,1′-(methylenedi-4, 1-phenylene)bismaleimide (BMI). After stirring at room temperature for 3 hrs, the THF was slowly removed by centrifugation. The resultant viscous liquid (at wt. %: 15, 25, 30, and 35) was mixed with inorganic conductor (e.g., lithium-ion conducting argyrodite) in dichlorobenzene. 8×Ø=10 mm zirconia balls were placed in the cup as mixing media. The cup was closed and tightly sealed with an insulating tape. The slurry was mixed for 16 hrs at 80 rpm speed on a tube roller. A thin film was cast on a nickel foil using a doctor blade technique. The casting was done on a coater equipped with a vacuum chuck. The film dried under ambient pressure at room temperature and 45° C. for 5 hours, then transferred to an antechamber and further dried under vacuum overnight. The dry thin film was cut into 50 mm×70 mm rectangle specimens. A single film piece was sandwiched between FEP sheets and pressed in a vertical press at 15 MPa for 18 hrs, while heating the sample at 100° C. The sample was cooled to 40° C. before the pressure was released and sample extracted.

### Inorganic Phase

The inorganic phase of the composite materials described herein conducts alkali ions. In some embodiments, it is responsible for all of the ion conductivity of the composite material, providing ionically conductive pathways through the composite material.

The inorganic phase is a particulate solid-state material that conducts alkali ions. In the examples given below, lithium ion conducting materials are chiefly described, though sodium ion conducting or other alkali ion conducting materials may be employed. According to various embodiments, the materials may be glass particles, ceramic particles, or glass ceramic particles. The methods are particularly useful for composites having glass or glass ceramic particles. In particular, as described above, the methods may be used to provide composites having glass or glass ceramic particles and a polar polymer without inducing crystallization (or further crystallization) of the particles.

The solid-state compositions described herein are not limited to a particular type of compound but may employ any solid-state inorganic ionically conductive particulate material, examples of which are given below.

In some embodiments, the inorganic material is a single ion conductor, which has a transference number close to unity. The transference number of an ion in an electrolyte is the fraction of total current carried in the electrolyte for the ion. Single-ion conductors have a transference number close to unity. According to various embodiments, the transference number of the inorganic phase of the solid electrolyte is at least 0.9 (for example, 0.99).

The inorganic phase may be an oxide-based composition, a sulfide-based composition, or a phosphate-based composition, and may be crystalline, partially crystalline, or amorphous. As described above, the certain embodiments of methods are particularly useful for sulfide-based compositions, which can degrade in the presence of polar polymers.

In certain embodiments, the inorganic phase may be doped to increase conductivity. Examples of solid lithium ion conducting materials include perovskites (e.g., Li₃ₓLa_{(2/3)-x}TiO₃, 0≤x≤0.67), lithium super ionic conductor (LISICON) compounds (e.g., Li₂₊₂ₓZn₁₋ₓGeO₄, 0≤x≤1; Li₁₄ZnGe₄O₁₆), thio-LISICON compounds (e.g., Li₄₋ₓA_{1-y}B_{y}S₄, A is Si, Ge or Sn, B is P, Al, Zn, Ga; Li₁₀SnP₂Si₂), garnets (e.g. Li₇La₃Zr₂O₁₂, Li₅La₃M₂O₁₂, M is Ta or Nb); NASICON-type Li ion conductors (e.g., Li_{1.3}Al_{0.3}Ti_{1.7}(PO₄)₃), oxide glasses or glass ceramics (e.g., Li₃BO₃—Li₂SO₄, Li₂O—P₂O₅, Li₂O—SiO₂), argyrodites (e.g. Li₆PS₅X where X=Cl, Br, I), sulfide glasses or glass ceramics (e.g., 75Li₂S-25P₂S₅, Li₂S—SiS₂, LiI—Li₂S—B₂S₃) and phosphates (e.g., Li₁₋ₓAlₓGe₂₋ₓ(PO₄)₃ (LAGP), Li₁₊ₓTi₂₋ₓAlₓ(PO₄)). Further examples include lithium rich anti-perovskite (LiRAP) particles. As described in Zhao and Daemen, J. Am. Chem. Soc., 2012, Vol. 134(36), pp. 15042-15047, incorporated by reference herein, these LiRAP particles have an ionic conductivity of greater than 10⁻³ S/cm at room temperature.

Examples of solid lithium ion conducting materials include sodium super ionic conductor (NASICON) compounds (e.g., Na₁₊ₓZr₂SiₓP₃₋ₓO₁₂, 0<x<3). Further examples of solid lithium ion conducting materials may be found in Cao et al., Front. Energy Res., 2014, Vol. 2, Article 25 (10 pp.); and Knauth, Solid State Ionics, 2009, Vol. 180(14-16), pp. 911-916, both of which are incorporated by reference herein.

Further examples of ion conducting glasses are disclosed in Ribes et al., J. Non-Cryst. Solids, 1980, Vol. 38-39 (Pt. 1), pp. 271-276 and Minami, J. Non-Cryst. Solids, 1987, Vol. 95-96, pp. 107-118, which are incorporated by reference herein.

According to various embodiments, an inorganic phase may include one or more types of inorganic ionically conductive particles. The particle size of the inorganic phase may vary according to the particular application, with an average diameter of the particles of the composition being between 0.1 μm and 500 μm for most applications. In some embodiments, the average diameter is between 0.1 μm and 100 μm. In some embodiments, a multi-modal size distribution may be used to optimize particle packing. For example, a bi-modal distribution may be used. In some embodiments, particles having a size of 1 μm or less are used such that the average nearest particle distance in the composite is no more than 1 μm. This can help prevent dendrite growth. In some embodiments, average particle size is less 10 μm or less than 7 μm. In some embodiments, a multi-modal size distribution having a first size distribution with an average size of less than 7 μm and a second size of greater than 10 μm may be used. Larger particles lead to membranes with more robust mechanical properties and better conductivities, while smaller particles give more compact, uniform films with lower porosity and better density.

The inorganic phase may be manufactured by any appropriate method. For example, crystalline materials may be obtained using different synthetic methods such as solution, sol-gel, and solid state reactions. Glass electrolytes may be obtained by quench-melt, solution synthesis or mechanical milling as described in Tatsumisago et al., J. Power Sources, 2014, Vol. 270, pp. 603-607, incorporated by reference herein.

As used herein, the term amorphous glass material refers to materials that are at least half amorphous though they may have small regions of crystallinity. For example, an amorphous glass particle may be fully amorphous (100% amorphous), at least 95% (vol). amorphous, at least 80% (vol.) amorphous, or at least 75% (vol.) amorphous. While these amorphous particles may have one or more small regions of crystallinity, ion conduction through the particles is through conductive paths that are mostly or wholly isotropic.

Ionically conductive glass-ceramic particles have amorphous regions but are at least half crystalline, for example, having at least 75% (vol.) crystallinity. Glass-ceramic particles may be used in the composites described, herein, with glass-ceramic particles having a relatively high amount of amorphous character (e.g., at least 40% (vol.) amorphous) useful in certain embodiments for their isotropic conductive paths. In some embodiments, ionically conductive ceramic particles may be used. Ionically conductive ceramic particles refer to materials that are mostly crystalline though they may have small amorphous regions. For example, a ceramic particle may be fully crystalline (100% vol. crystalline) or at least 95% (vol). crystalline.

In some embodiments, the inorganic phase includes argyrodites. The argyrodites may have the general formula:

A₇₋ₓPS₆₋ₓHalₓ,

wherein A is an alkali metal and Hal is selected from chlorine (Cl), bromine (Br), and iodine (I). In particular embodiments, x is more than 0. In other embodiments, x is 3 or less. In yet other embodiments, 0<x≤2.

In some embodiments, the argyrodite may have a general formula as given above, and further be doped. An example is argyrodites doped with thiophilic metals:

A_{7-x-(z*m)}M^{z}ₘPS₆₋ₓHalₓ,

wherein A is an alkali metal; M is a metal selected from manganese (Mn), iron (Fe), cobalt (Co), nickel (Ni), copper (Cu), zinc (Zn), and mercury (Hg); Hal is selected from chlorine (C₁), bromine (Br), and iodine (I); z is the oxidation state of the metal; 0≤x≤2; and 0≤m<(7−x)/z. In some embodiments, A is lithium (Li), sodium (Na) or potassium (K). In some embodiments, A is Li. Metal-doped argyrodites are described further in U.S. patent application Ser. No. 16/829,962, published as U.S. Patent Pub. No. 2021-0047195, incorporated by reference herein. In some embodiments, the composite may include oxide argyrodites, for example, as described in U.S. patent application Ser. No. 16/576,570, published as U.S. Patent Pub. No. 2020-0087155, incorporated by reference herein. Alkali metal argyrodites include argyrodites of the formulae given above as well as argyrodites described in U.S. Patent Pub. No. 2017-0352916 which include Li_{7-x+y}PS₆₋ₓCl_{x+y} where x and y satisfy the formula 0.05≤y≤0.9 and −3.0x+1.8≤y≤−3.0x+5, or other argyrodites with A_{7-x+y}PS₆₋ₓHal_{x+y} formula. Such argyrodites may also be doped with metal as described above, which include A_{7-x+y-(z*m)}M^{z}ₘPS₆₋ₓHal_{x+y}.

The mineral Argyrodite, AgsGeS₆, can be thought of as a co-crystal of Ag₄GeS₄ and two equivalents of Ag₂S. Substitutions in both cations and anions can be made in this crystal while still retaining the same overall spatial arrangement of the various ions. In Li₇PS₆, PS₄³⁻ ions reside on the crystallographic location occupied by GeS₄⁴⁻ in the original mineral, while S²⁻ ions retain their original positions and Li⁺ ions take the positions of the original Ag⁺ ions. As there are fewer cations in Li₇PS₆ compared to the original AgSGeS₆, some cation sites are vacant. These structural analogs of the original Argyrodite mineral are referred to as argyrodites as well.

Both AgSGeS₆ and Li₇PS₆ are orthorhombic crystals at room temperature, while at elevated temperatures phase transitions to cubic space groups occur. Making the further substitution of one equivalent of LiCl for one Li₂S yields the material Li₆PS₅Cl, which still retains the argyrodite structure but undergoes the orthorhombic to cubic phase transition below room temperature and has a significantly higher lithium-ion conductivity. Because the overall arrangement of cations and anions remains the same in this material as well, it is also commonly referred to as an argyrodite. Further substitutions which also retain this overall structure may therefore also be referred to as argyrodites. Alkali metal argyrodites more generally are any of the class of conductive crystals with alkali metals occupying Ag+ sites in the original Argyrodite structure, and which retain the spatial arrangement of the anions found in the original mineral.

In one example, a lithium-containing example of this mineral type, Li₇PS₆, PS₄³⁻ ions reside on the crystallographic location occupied by GeS₄⁴⁻ in the original mineral, while S²⁻ ions retain their original positions and Li⁺ ions take the positions of the original Ag⁺ ions. As there are fewer cations in Li₇PS₆ compared to the original AgSGeS₆, some cation sites are vacant. As indicated above, making the further substitution of one equivalent of LiCl for one Li₂S yields the material Li₆PS₅Cl, which still retains the argyrodite structure. In one example of a cubic argyrodite Li₆PS₅Cl, Li⁺ occupies the Ag⁺ sites in the Argyrodite mineral, PS₄³⁻ occupies the GeS₄⁴⁻ sites in the original, and a one to one ratio of S²⁻ and Cl⁻ occupy the two original S²⁻ sites.

There are various manners in which substitutions may be made that retain the overall argyrodite structure. For example, the original mineral has two equivalents of S²⁻, which can be substituted with chalcogen ions such as O²⁻, Se²⁻, and Te²⁻. A significant fraction of the of S²⁻ can be substituted with halogens. For example, up to about 1.6 of the two equivalents of S²⁻ can be substituted with Cl⁻, Br⁻, and I⁻¹, with the exact amount depending on other ions in the system. While Cl⁻ is similar in size to S²⁻, it has one charge instead of two and has substantially different bonding and reactivity properties. Other substitutions may be made, for example, in some cases, some of the S²⁻ can be substituted with a halogen (e.g., Cl⁻) and the rest replaced with Se²⁻. Similarly, various substitutions may be made for the GeS₄³⁻ sites. PS₄³⁻ may replace GeS₄³⁻; also PO₄³⁻, PSe₄³⁻, SiS₄³⁻, etc. These are all tetrahedral ions with four chalcogen atoms, overall larger than S²⁻, and triply or quadruply charged.

In other examples, which will be compared to the Li₆PS₅Cl argyrodite structure described above, Li₆PS₅Br and Li₆PS₅I substitute larger halides in place of the chloride, e.g., Li₆PO₅Cl and Li₆PO₅Br. See Kong et al., Z. anorg. allg. Chem. [J. Inorg. Gen. Chem. ], 2010, Vol. 636, pp. 1920-1924, incorporated by reference herein for the purpose of describing certain argyrodites, contain the halide substitutions described as well as exchanging every sulfur atom in the structure, in both the S²⁻ and PS₄³⁻ ions, for oxygen. The phosphorus atoms in the PS₄³⁻ ions found in most examples of lithium-containing argyrodites can also be partially or wholly substituted, for instance the series Li₇₊ₓMₓP₁₋ₓS₆ (M=Si, Ge) forms argyrodite structures over a wide range of x. See Zhang et al., J. Mater. Chem. A, 2019, Vol. 7, pp. 2717-2722, incorporated by reference herein for the purpose of describing certain argyrodites. Substitution for P can also be made while incorporating halogens. For example, Li₆₊ₓSiₓP₁₋ₓSSBr is stable from x=0 to about 0.5. See Minafra et al., J. Mater. Chem. A, 2018, Vol. 6, pp. 645-651, incorporated by reference herein for the purpose of describing certain argyrodites. Compounds in the series Li₇₊ₓMₓSb₁₋ₓS₆ (M=Si, Ge, Sn), where a mixture of SbS₄³⁻ and MS₄⁴⁻ are substituted in place of PS₄³⁻ and I⁻ is used in place of Cl⁻, have been prepared and found to form the argyrodite structure. See Zhou et al., J. Am. Chem. Soc., 2019, Vol. 141, pp. 19002-19013, incorporated by reference herein for the purpose of describing certain argyrodites. Other cations besides lithium (or silver) can also be substituted into the cation sites. Cu₆PS₅Cl, Cu₆PS₅Br, Cu₆PS₅I, Cu₆AsS₅Br, Cu₆AsS₅I, Cu_{7.82}SiS_{5.82}Br_{0.15}, Cu₇SiS₅I, Cu_{7.49}SiS_{5.49}I_{0.51}, Cu_{7.44}SiSe_{5.44}I_{0.56}, Cu_{7.75}GeS_{5.75}Br_{0.25}, Cu₇GeS₅I and Cu_{7.52}GeSe_{5.52}I_{0.48} have all been synthesized and have argyrodite crystal structures. See Nilges and Pfitzner, Z. Kristallogr., 2005, Vol. 220, pp. 281-294, incorporated by reference herein for the purpose of describing certain argyrodites. From the list of examples, it can be seen that not only can single elements be substituted in any of the various parts of the argyrodite structure, but combinations of substitutions also often yield argyrodite structures. These include argyrodites described in U.S. Patent Pub. No. 2017/0352916, which include Li₇₋ₓ+_{y}PS₆₋ₓCl_{x+y} where x and y satisfy the formula 0.05≤y≤0.9 and −3.0x+1.8≤y≤−3.0x+5.7.

The argyrodites used in the compositions herein described include sulfide-based ion conductors with a substantial (at least 20%, and often at least 50%) of the anions being sulfur-containing (e.g., S²⁻ and PS₄³⁻). Sulfide-based lithium argyrodite materials exhibit high Li⁺ mobility and are of interest in lithium batteries. As indicated above, an example material in this family is Li₆PS₅Cl, which is a ternary co-crystal of Li₃PS₄, Li₂S, and LiCl. Various embodiments of argyrodites described herein have thiophilic metals that may occupy lithium cation sites in the argyrodite crystal structure. For example, each cation may be coordinated to two sulfurs which are members of PS₄³⁻ anions, one S²⁻ sulfur anion, and two chloride anions. In some embodiments, a thiophilic metal occupies some fraction of these lithium cation sites to suppress hydrogen sulfide generation. Thiophilic metals may be used to similarly dope other alkali metal argyrodites.

### Composites

Provided herein are composites including organic phase and non-ionically conductive particles. In some embodiments, the organic phase has substantially no ionic conductivity, and is referred to as “non-ionically conductive.” Non-ionically conductive polymers described herein have ionic conductivities of less than 0.0001 S/cm. In some embodiments, the organic phase may include a polymer that is ionically conductive in the present of a salt such as LiI. Ionically conductive polymers such as polyethylene oxide (PEO), polypropylene oxide (PPO), polyacrylonitrile (PAN), poly(methyl methacrylate) (PMMA), which are ionically conductive in presence of a salt dissolve or dissociate salts such as LiI. Non-ionically conductive polymers do not dissolve or dissociate salts and are not ionically conductive even in the presence of a salt. This is because without dissolving a salt, there are no mobile ions to conduct.

The polymer loading in the solid phase composites may be relatively high in some embodiments, e.g., being at least 2.5%-30% by weight. According to various embodiments, it may between 0.5 wt. %-60 wt. % polymer, 1 wt. %-40 wt. % polymer, or 5 wt. %-30 wt. %. The solid phase composites form a continuous film.

As indicated above, the composite contains a functionalized polymer backbone binder. The binder may be a mixture of functionalized and non-functionalized polymer binders. For example, in some embodiments, a binder may be a mixture of a non-polar polymer (e.g., SEBS) and a functionalized version of the polymer, which the functionalized version of the polymer may be crosslinked as described herein (e.g., SEBS-gFA, SEBS-gFA-0.5BMI). A mixture may be 1:9-9:1 wt. % polymer:functionalized polymer according to various embodiments, e.g., 1:5-5:1, or between 1:4-4:1.

According to various embodiments, the polymer binder may be essentially all of the organic phase of the composite, or at least 95 wt. %, 90 wt. %, at least 80 wt. %, at least 70 wt. %, at least 60 wt. %, or at least 50 wt. %, of the composite.

In some embodiments, the composites consist essentially of ion-conductive inorganic particles and the organic phase. However, in alternative embodiments, one or more additional components may be added to the solid composites.

According to various embodiments, the solid compositions may or may not include an added salt. Lithium salts (e.g., LiPF₆, LiTFSI), potassium salts, sodium salts, etc. can be added to improve ionic conductivity in embodiments that include an ionically conductive polymer such as PEO. In some embodiments, the solid-state compositions include substantially no added salts. “Substantially no added salts” means no more than a trace amount of a salt. In some embodiments, the ionic conductivity of the composite is substantially provided by the inorganic particles. Even if an ionically conductive polymer is used, it may not contribute more than 0.01 mS/cm, 0.05 mS/cm. or 0.1 mS/cm to the ionic conductivity of the composite. In other embodiments, it may contribute more.

In some embodiments, the solid-state composition may include one or more conductivity enhancers. In some embodiments, the electrolyte may include one or more filler materials, including ceramic fillers such as Al₂O₃. If used, a filler may or may not be an ion conductor depending on the particular embodiment. In some embodiments, the composite may include one or more dispersants. Further, in some embodiments, an organic phase of a solid-state composition may include one or more additional organic components to facilitate manufacture of an electrolyte having mechanical properties desired for a particular application.

In some embodiments, discussed further below, the composites are incorporated into, or are ready to be incorporated into, an electrode and include electrochemically active material, and optionally, an electronically conductive additive. Examples of constituents and compositions of electrodes are provided below.

In some embodiments, the electrolyte may include an electrode stabilizing agent that can be used to form a passivation layer on the surface of an electrode. Examples of electrode stabilizing agents are described in U.S. Pat. No. 9,093,722. In some embodiments, the electrolyte may include conductivity enhancers, fillers, or organic components as described above.

The composite may be provided as a free-standing film, a free-standing film that is provided on a release film, a film that has been laminated on component of a battery or other device such as an electrode or a separator, or a film that has been cast onto an electrode, separator, or other component.

A composite film may be of any suitable thickness depending upon the particular battery or other device design. For many applications, the thickness may be between 1 micron and 250 microns, for example 30 microns. In some embodiments, the electrolyte may be significantly thicker, e.g., on the order of millimeters.

In some embodiments, the composites are provided as a slurry or paste. In such cases, the composition includes a solvent to be later evaporated. In addition, the composition may include one or more components for storage stability. Such compounds can include an acrylic resin. Once ready for processing the slurry or paste may be cast or spread on a substrate as appropriate and dried.

In some embodiments, the composites are provided as solid mixtures that can be extruded.

Devices

The composites described herein may be incorporated into any device that uses an ionic conductor, including but not limited to batteries and fuel cells. In a battery, for example, the composite may be used as an electrolyte separator.

The electrode compositions further include an electrode active material, and optionally, a conductive additive. Example cathode and anode compositions are given below.

For cathode compositions, Table 3 below gives examples of compositions.

TABLE 3

| | | | Electronic | |
|---|---|---|---|---|
| Constituent | Active material | Inorganic conductor | conductivity additive | Organic phase |
| Examples | Transition Metal Oxide | Argyrodites (e.g., | Carbon-based | PVDF-PS copolymer |
| | Transition Metal Oxide with | Li₆PS₅Cl, | Activated carbons | PVDF:PVDF-PS |
| | layer structure | Li_{5.6}PS_{4.6}Cl_{1.4}, | Carbon nanotubes | copolymer |
| | Lithium nickel manganese | Li_{5.4}Cu_{0.1}PS_{4.6}Cl_{1.4}, | (CNTs) | SEBS:PVDF-PS |
| | cobalt oxide (NMC) | Li_{5.8}Cu_{0.1}PS₅Cl, | Graphene | copolymer |
| | Lithium nickel cobalt | Na_{5.8}Cu_{0.1}PS₅Cl) | Graphite | Functionalized, |
| | aluminum oxide (NCA, | Sulfide glasses or | Carbon fibers | crosslinkable binders |
| | LiNiCoAlO₂) | glass ceramics (e.g., | Carbon black (e.g., | Crosslinking agents |
| | Lithium iron phosphate | 75Li₂S•25P₂S₅) | Super C) | SEBS, SBR, or SIS |
| | (LiFePO₄) | | | |
| | Lithium cobalt oxide (LiCoO₂) | | | |
| Wt. % range | 65%-90% | 8%-33% | 1%-5% | 1%-5% |

According to various embodiments, the cathode active material is a transition metal oxide, with lithium nickel manganese cobalt oxide (LiNiMnCoO₂, or NMC) as an example. Various forms of NMC may be used, including LiNi_{0.6}Mn_{0.2}Co_{0.2}O₂ (NMC-622), LiNi_{0.4}Mn_{0.3}Co_{0.3}O₂ (NMC-4330), etc. The lower end of the wt. % range is set by energy density; compositions having less than 65 wt. % active material have low energy density and may not be useful.

Any appropriate inorganic conductor may be used as described above in the description of inorganic conductors. Li_{5.6}PS_{4.6}C_{1.4} is an example of an argyrodite with high conductivity. Li_{5.4}Cu_{0.1}PS_{4.6}Cl_{1.4} is an example of an argyrodite that retains high ionic conductivity and suppresses hydrogen sulfide. Compositions having less than 10 wt. % argyrodite have low Li⁺ conductivity. Sulfide glasses and glass ceramics may also be used.

An electronic conductivity additive is useful for active materials that, like NMC, have low electronic conductivity. Carbon black is an example of one such additive, but other carbon-based additives including other carbon blacks, activated carbons, carbon fibers, graphites, graphenes, and carbon nanotubes (CNTs) may be used. Below 1 wt. % may not be enough to improve electronic conductivity while greater than 5% leads to decrease in energy density and disturbing active material-argyrodite contacts.

Any appropriate organic phase may be used as described above. Below 1 wt. % may not be enough to achieve desired mechanical properties while greater than 5% can lead to decrease in energy density and disturbing active material-inorganic conductor-carbon contacts. In some embodiments, polyvinylidene difluoride (PVDF) is used with or without a non-polar polymer (e.g., polystyrene or PS).

For anode compositions, Table 4 below gives examples of compositions.

TABLE 4

| | Primary | Secondary | | Electronic | |
|---|---|---|---|---|---|
| Constituent | active material | active material | Inorganic conductor | conductivity additive | Organic phase |
| Examples | Si-containing | Graphite | Argyrodites (e.g., | Carbon-based | PVDF-PS |
| | Elemental Si | | Li₆PS₅Cl, | Activated | copolymer |
| | Silicon oxide | | Li_{5.6}PS_{4.6}Cl_{1.4}, | carbons | PVDF:PVDF- |
| | Silicon-carbon composite | | Li_{5.4}Cu_{0.1}PS_{4.6}Cl_{1.4}, | CNTs | PS copolymer |
| | Si alloys, e.g., Si alloyed with | | Li_{5.8}Cu_{0.1}PS₅Cl, | Graphene | SEBS:PVDF- |
| | one or more of Al, Zn, Fe, | | Na_{5.8}Cu_{0.1}PS₅Cl) | Carbon fibers | PS copolymer |
| | Mn, Cr, Co, Ni, Cu, Ti, Mg, | | Sulfide glasses or | Carbon black | Functionalized, |
| | Sn, Ge | | glass ceramics (e.g., | (e.g., Super C) | crosslinkable |
| | | | 75Li₂S•25P₂S₅) | | binders |
| | | | | | Crosslinking |
| | | | | | agents |
| | | | | | SEBS, SBR, or |
| | | | | | SIS |
| Wt. % range | Si is 15%-65% | 5%-60% | 10%-50% | 0%-5% | 1%-5% |

Graphite can be used as a secondary active material to improve initial coulombic efficiency (ICE) of the Si anodes. Si suffers from low ICE (e.g., less than 80% in some cases) which is lower than ICE of NMC and other cathodes causing irreversible capacity loss on the first cycle. Graphite has high ICE (e.g., greater than 90%) enabling full capacity utilization. Hybrid anodes where both Si and graphite are utilized as active materials deliver higher ICE with increasing graphite content meaning that ICE of the anode can match ICE of the cathode by adjusting Si/graphite ratio thus preventing irreversible capacity loss on the first cycle. ICE can vary with processing, allowing for a relatively wide range of graphite content depending on the particular anode and its processing. In addition, graphite improves electronic conductivity and may help densification of the anode.

Any appropriate inorganic conductor may be used as described above with respect to cathodes.

A high-surface-area electronic conductivity additive (e.g., carbon black) may be used some embodiments. Si has low electronic conductivity and such additives can be helpful in addition to graphite (which is a great electronic conductor but has low surface area). However, electronic conductivity of silicon-carbon composite materials and silicon-containing alloys can be reasonably high making usage of the additives unnecessary in some embodiments. Other high-surface-area carbons (carbon blacks, activated carbons, graphenes, carbon nanotubes) can also be used instead of Super C.

Any appropriate organic phase may be used. In some embodiments, PVDF is used.

Provided herein are alkali metal batteries and alkali metal ion batteries that include an anode, a cathode, and a compliant solid electrolyte composition as described above operatively associated with the anode and cathode. The batteries may include a separator for physically separating the anode and cathode; this may be the solid electrolyte composition.

Examples of suitable anodes include but are not limited to anodes formed of lithium metal, lithium alloys, sodium metal, sodium alloys, carbonaceous materials such as graphite, and combinations thereof. Examples of suitable cathodes include, but are not limited to cathodes formed of transition metal oxides, doped transition metal oxides, metal phosphates, metal sulfides, lithium iron phosphate, sulfur and combinations thereof. In some embodiments, the cathode may be a sulfur cathode.

In an alkali metal-air battery such as a lithium-air battery, sodium-air battery, or potassium-air battery, the cathode may be permeable to oxygen (e.g., mesoporous carbon, porous aluminum, etc.), and the cathode may optionally contain a metal catalyst (e.g., manganese, cobalt, ruthenium, platinum, or silver catalysts, or combinations thereof) incorporated therein to enhance the reduction reactions occurring with lithium ion and oxygen at the cathode.

In some embodiments, lithium-sulfur cells are provided, including lithium metal anodes and sulfur-containing cathodes. In some embodiments, the solid-state composite electrolytes described herein uniquely enable both a lithium metal anode, by preventing dendrite formation, and sulfur cathodes, by not dissolving polysulfide intermediates that are formed at the cathode during discharge.

A separator formed from any suitable material permeable to ionic flow can also be included to keep the anode and cathode from directly electrically contacting one another. However, as the electrolyte compositions described herein are solid compositions, they can serve as separators, particularly when they are in the form of a film.

In some embodiments, the solid electrolyte compositions serve as electrolytes between anodes and cathodes in alkali ion batteries that rely on intercalation of the alkali ion during cycling.

As described above, in some embodiments, the solid composite compositions may be incorporated into one of or both the anode and cathode of a battery. The electrolyte may be a compliant solid electrolyte as described above or any other appropriate electrolyte, including liquid electrolyte.

In some embodiments, a battery includes an electrode/electrolyte bilayer, with each layer incorporating the ionically conductive solid-state composite materials described herein.

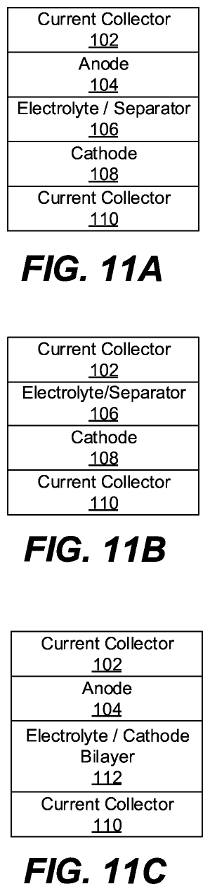

FIG. 11A shows an example of a schematic of a cell according to certain embodiments of the invention. The cell includes a negative current collector 102, an anode 104, an electrolyte/separator 106, a cathode 108, and a positive current collector 110. The negative current collector 102 and the positive current collector 110 may be any appropriate electronically conductive material, such as copper, steel, gold, platinum, aluminum, and nickel. In some embodiments, the negative current collector 102 is copper and the positive current collector 110 is aluminum. The current collectors may be in any appropriate form, such as a sheet, foil, a mesh, or a foam. According to various embodiments, one or more of the anode 104, the cathode 108, and the electrolyte/separator 106 is a solid-state composite including an organic phase and inorganic phase as described above. In some embodiments, two or more of the anode 104, the cathode 108, and the electrolyte 106 is solid-state composite including an organic phase and inorganic phase, as described above.

In some embodiments, a current collector is a porous body that can be embedded in the corresponding electrode. For example, it may be a mesh. Electrodes that include hydrophobic polymers may not adhere well to current collectors in the form of foils; however meshes provide good mechanical contact. In some embodiments, two composite films as described herein may be pressed against a mesh current collector to form an embedded current collector in an electrode. In some embodiments, a hydrophilic polymer that provides good adhesion is used.

FIG. 11B shows an example of schematic of a lithium metal cell as-assembled according to certain embodiments of the invention. The cell as-assembled includes a negative current collector 102, an electrolyte/separator 106, a cathode 108, and a positive current collector 110. Lithium metal is generated on first charge and plates on the negative current collector 102 to form the anode. One or both of the electrolyte 106 and the cathode 108 may be a composite material as described above. In some embodiments, the cathode 108 and the electrolyte 306 together form an electrode/electrolyte bilayer. FIG. 11C shows an example of a schematic of a cell according to certain embodiments of the invention. The cell includes a negative current collector 102, an anode 104, a cathode/electrolyte bilayer 112, and a positive current collector 110. Each layer in a bilayer may include a sulfidic conductor. Such a bilayer may be prepared, for example, by preparing an electrolyte slurry and depositing it on an electrode layer.

All components of the battery can be included in or packaged in a suitable rigid or flexible container with external leads or contacts for establishing an electrical connection to the anode and cathode, in accordance with known techniques.

In some embodiments, a composite separator includes an organic phase that undergoes an in situ byproduct free polymerization, as described herein. In some embodiments, one or both electrodes for a battery may have an organic phase that may undergo in situ byproduct free polymerization. In some embodiments, each of the composite separator and the two electrodes are separately formed and assembled.

In some implementations, the composite separator and one or both electrodes are cross-linked via a byproduct free reaction as described herein. In such embodiments, the composite separator and one or both electrodes include an organic phase having a polymer and small molecules functionalized with byproduct free reactive groups, e.g., Diels-Alder reactive groups. In some embodiments, the molecules functionalized with Diels-Alder reactive groups may be part of the separator and/or one or both electrodes. In such embodiments, during a polymerization step the reactive groups may cross-link between the composite separator and the one or both electrodes. Thus, the composite separator and the one or both electrodes have cross-linked polymer matrices substantially without byproducts. This technique may lead to a full cell with an in situ separator with higher mechanical properties without the formation of byproducts.

### Processing

The solid-state compositions may be prepared by any appropriate method. According to various embodiments, in situ polymerization is performed by mixing ionically conductive particles, polymer precursors and any binders, initiators, catalysts, cross-linking agents, and other additives if present, and then initializing polymerization. This may be in solution or dry-pressed as described later. The polymerization may be initiated and carried out under applied pressure to establish intimate particle-to-particle contact.

Uniform films can be prepared by solution processing methods. In one example method, all components are mixed together by using laboratory and/or industrial equipment such as sonicators, homogenizers, high-speed mixers, rotary mills, vertical mills, and planetary ball mills. Mixing media can be added to aid homogenization, by improving mixing, breaking up agglomerates and aggregates, thereby eliminating film imperfection such as pin-holes and high surface roughness. The resulting mixture is in a form of uniformly mixed slurry with a viscosity varying based on the hybrid composition and solvent content. The substrate for casting can have different thicknesses and compositions. Examples include aluminum, copper, and mylar. The inorganic particles may be added to slurry before addition of crosslinker or at the same time, but generally not after crosslinking.

The casting of the slurry on a selected substrate can be achieved by different industrial methods. In some embodiments, porosity can be reduced by mechanical densification of films (resulting in, for example, up to about 50% thickness change) by methods such as calendaring between rollers, vertical flat pressing, or isostatic pressing. The pressure involved in densification process forces particles to maintain a close inter-particle contact. External pressure, e.g., on the order of 1 MPa to 600 MPa, or 1 MPa to 100 MPa, is applied. In some embodiments, pressures as exerted by a calender roll are used. The pressure is sufficient to create particle-to-particle contact, though kept low enough to avoid uncured polymer from squeezing out of the press. Polymerization, which may include cross-linking, may occur under pressure to form the matrix. In some implementations, a thermal-initiated or photo-initiated polymerization technique is used in which application of thermal energy or ultraviolet light is used to initiate polymerization. The ionically conductive inorganic particles are trapped in the matrix and stay in close contact on release of external pressure. The composite prepared by the above methods may be, for example, pellets or thin films and is incorporated to an actual solid-state lithium battery by well-established methods.

In some embodiments, solid-state composite separators are produced via in situ, thermally curable polymers without forming byproducts during a manufacturing process of the full cell. For example, a polymer and small molecules functionalized with Diels-Alder reactive groups will react during a calendering step of the full cell at a given temperature and pressure (e.g., temperatures between 60° C. and 140° C., and pressure between 0.2 ton/cm to 3 ton/cm). The polymer may be part of the separator and/or the electrodes; and molecules functionalized with Diels-Alder reactive groups may be part the separator and/or the electrodes. The polymerization during calendering of the full cell (under a controlled temperature and pressure) will lead to a full cell with an in situ separator with higher mechanical properties without the formation of byproducts.

In some embodiments, the films are dry-processed rather than processed in solution. For example, the films may be extruded. Extrusion or other dry processing may be alternatives to solution processing especially at higher loadings of the organic phase (e.g., in embodiments in which the organic phase is at least 30 wt. %).

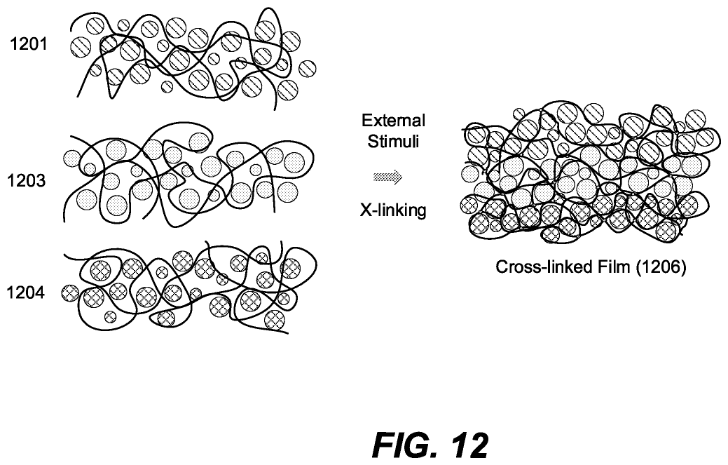

FIG. 12 provides an example of a schematic depiction of multiple cast films including ionically conductive inorganic particles in a polymer matrix undergoing in situ polymerization to cross-link the polymer chains, such as during calendering of a fuel cell. In the example of FIG. 12, three films, a first electrode 1201, a separator 1203, and a second electrode 1204 each include various particles in a polymer matrix. Each polymer matrix may be functionalized with reactive groups that do not form byproducts, e.g. Diels-Alder reactive groups. The particles and other components of the first electrode, separator, and second electrode are discussed elsewhere herein. In some embodiments, the films may be subject to an applied pressure that densifies the film and forces the ionically conductive particles into close contact. An external stimulus is applied to initiate polymerization, which in the example of FIG. 12, cross-links polymer chains of the polymer matrices of each film 1206. Specifically, the polymer matrix of the first electrode 1201, separator 1203, and/or second electrode 1204 may be cross-linked with the polymer matrices of a separate film following polymerization. In embodiments where a pressure is applied to the films, the pressure is released, with the cross-linked film remaining dense with the ionically conductive particles into close contact. In some embodiments, there is only one electrode film and the separator, where the same process may be used, leading to a cross-linked polymer matrix between the electrode and the separator.

### CONCLUSION

Although the foregoing embodiments have been described in some detail for purposes of clarity of understanding, it will be apparent that certain changes and modifications may be practiced within the scope of the appended claims. Embodiments disclosed herein may be practiced without some or all of these specific details. In other instances, well-known process operations have not been described in detail to not unnecessarily obscure the disclosed embodiments. Further, while the disclosed embodiments will be described in conjunction with specific embodiments, it will be understood that the specific embodiments are not intended to limit the disclosed embodiments. It should be noted that there are many alternative ways of implementing the processes, systems, and apparatus of the present embodiments. Accordingly, the present embodiments are to be considered as illustrative and not restrictive, and the embodiments are not to be limited to the details given herein.

1. A hybrid electrolyte composition comprising:
about 60 wt. % to about 95 wt. % of an ion conducting inorganic material; and
about 5 wt. % to about 40 wt. % of an in situ cross-linked matrix, wherein the matrix comprises a binder and a plurality of cross-linkers, wherein the cross-linkers form a thermally reversible bond within the matrix, and wherein the thermally reversible bond does not generate a byproduct.

2. The composition of claim 1, wherein the thermally reversible bond is formed by way of a Diels-Alder cycloaddition reaction, a Huisgen cycloaddition reaction, a thiol-ene reaction, a Michael addition reaction, a ring-opening reaction, or a click chemistry reaction.

3. The composition of claim 1, wherein the ion conducting inorganic material comprises lithium or a sulfide-based material.

4. (canceled)

5. The composition of claim 1, wherein the binder comprises a polymer backbone, a copolymer backbone, a graft copolymer backbone, or a plurality of inorganic cages.

6. The composition of claim 5, wherein the binder comprises a perfluoroether, an epoxy, a polybutadiene, a poly(styrene-b-butadiene), a polyolefin, a polysiloxane, a polytetrahydrofuran, a polystyrene, a polyethylene, a polybutylene, a poly (styrene-butadiene-styrene) (SBS), a poly (styrene-ethylene-butylene-styrene) (SEBS), a poly (styrene-isoprene-styrene) (SIS), an acrylonitrile butadiene rubber, an ethylene propylene diene monomer polymer, as well as copolymers thereof, silica, silsesquioxane, hydridosilsesquioxane, or partially condensed silsesquioxane.

7. (canceled)

8. (canceled)

9. (canceled)

10. (canceled)

11. The composition of claim 1, wherein the cross-linker has a structure of -L¹-X¹-L²-, -L¹-X¹-L²-X²-L³-, or (-L¹)(-L^{1a})X¹-L²-X²(L³-)(L^{3a}-), wherein:
each of L¹, L^{1a}, L², L³, and L^{3a} comprises, independently, an optionally substituted alkylene, optionally substituted heteroalkylene, or an optionally substituted arylene; and
each of X¹ or X² comprises, independently, a Diels-Alder cycloaddition product, a Huisgen cycloaddition product, a thiol-ene reaction product, a Michael addition product, or a ring-opening reaction product.

12. (canceled)

13. (canceled)

14. (canceled)

15. The composition of claim 11, wherein:
each of X¹ or X² comprises, independently, thio, a divalent linker comprising a heterocycle or a carbocycle, or a moiety selected from the group consisting 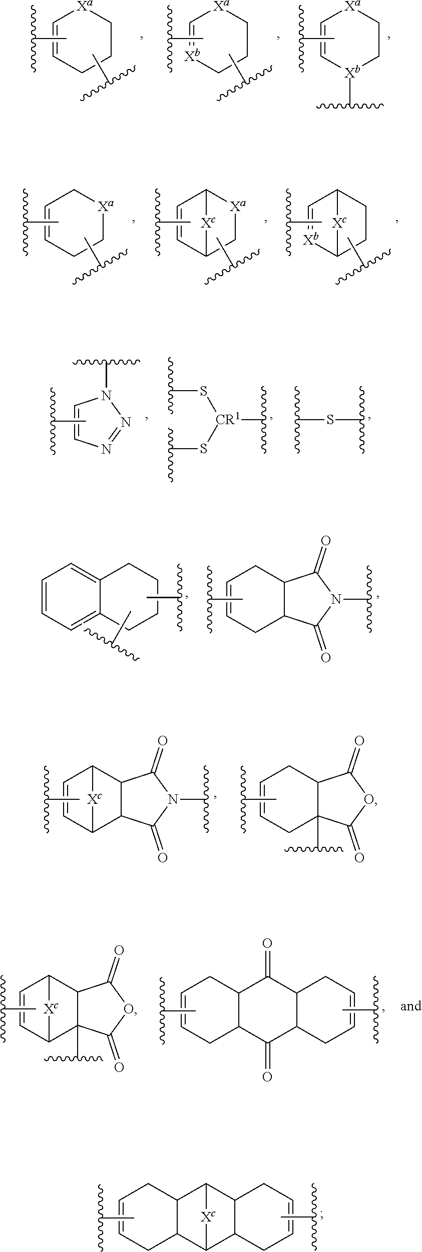
X^{a} is —C(R¹)₂—, —NR¹—, —O—, or —S—;
X^{b} is ═CR¹— or —N—;
X° is —[C(R¹)₂]_{c1}—, —NR¹—, —O—, —S—, or —C(O)—O—;
R¹ is H or optionally substituted alkyl;
c1 is an integer from 1 to 3; and
wherein the moiety is optionally substituted with cyano, hydroxyl, halo, nitro, carboxyaldehyde, carboxyl, alkoxy, oxo, or alkyl.

16. A film comprising a hybrid electrolyte composition of claim 1.

17. The film of claim 16, wherein an elastic modulus of the film is of from about 0.2 GPa to about 3 GPa.

18. A method of forming a hybrid electrolyte composition, the method comprising:
providing a mixture comprising a binder component bonded to a first linker having a first reactive group and an ion conducting inorganic material; and
reacting the binder component with a linking agent to form an in situ cross-linked matrix, wherein the linking agent comprises a second reactive group configured to react together with the first reactive group to form a thermally reversible bond within the matrix, and wherein the thermally reversible bond does not generate a byproduct.

19. The method of claim 18, wherein the first and second reactive groups react together to form a Diels-Alder cycloaddition product, a Huisgen cycloaddition product, a thiol-ene reaction product, a Michael addition product, or a ring-opening reaction product.

20. The method of claim 19, wherein the first and second reactive groups are selected from one of the following pairs: a diene and a dienophile; a 1,3-dipole and a dipolarophile; a thiol and an optionally substituted alkene; a thiol and an optionally substituted alkyne; a nucleophile and a strained heterocyclyl electrophile; a nucleophile and an optionally substituted α,β-unsaturated carbonyl compound; or a nucleophile and an optionally substituted strained cyclic compound.

21. (canceled)

22. The method of claim 18, wherein the binder component comprises a monomer bonded to the first linker having the first reactive group or an inorganic cage bonded to the first linker having the first reactive group.

23. The method of claim 22, wherein the binder component comprises the following structure:
—[R^{M}-(L*-R¹*)]ₙ— or —[R_{M1}]ₙ₁—[R^{M2}]ₙ₂—[R^{M3}—(*—R¹*)]ₙ₃—[R^{M4}]ₙ₄—, wherein:
R^{M} is the monomer;
R^{M1} is a first monomer;
R^{M2} is a second monomer;
R^{M3} is a third monomer;
R^{M4} is a fourth monomer;
L* is a divalent linker;
R¹* is the first reactive group;
n is 1 to 10; and
each of n1, n2, n3, and n4 is, independently, from 0 to 10, in which at least one of n1, n2, n3, and n4 is not 0.

24. (canceled)

25. (canceled)

26. (canceled)

27. (canceled)

28. The method of claim 22, wherein the binder component has the following structure:
R^{C}-(L*-R¹*)ₙ, wherein:
R^{C} is the inorganic cage or (SiO_{1.5})ₙ;
L* is a divalent linker;
R¹* is the first reactive group; and
n is 8, 10, or 12.

29. (canceled)

30. (canceled)

31. (canceled)

32. (canceled)

33. (canceled)

34. (canceled)

35. (canceled)

36. (canceled)

37. The method of claim 18, wherein the thermally reversible bond is formed by way of a Diels-Alder cycloaddition reaction, a Huisgen cycloaddition reaction, a thiol-ene reaction, a Michael addition reaction, a ring-opening reaction, or a click chemistry reaction, or wherein the thermally reversible bond comprises a Diels-Alder cycloaddition product, a Huisgen cycloaddition product, a thiol-ene reaction product, a Michael addition product, or a ring-opening reaction product.

38. (canceled)

39. (canceled)

40. The method of claim 18, wherein the thermally reversible bond comprises thio, an optionally substituted heterocyclyl, an optionally substituted cycloalkyl, or a moiety selected from the group consisting of 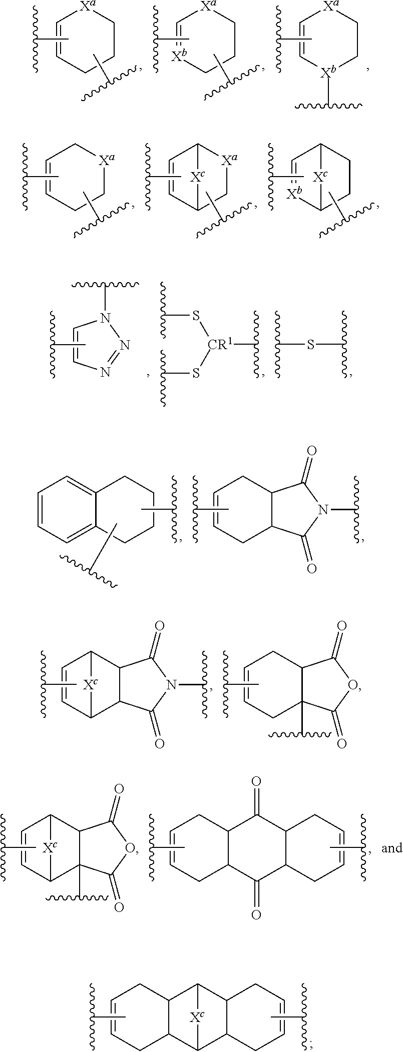
wherein:
X^{a} is —C(R¹)₂—, —NR¹—, —O—, or —S—;
X^{b} is ═CR¹— or —N—;
X^{c} is —[C(R¹)₂]_{c1}—, —NR¹—, —O—, —S—, or —C(O)—O—;
R¹ is H or optionally substituted alkyl;
c1 is an integer from 1 to 3; and
wherein the moiety is optionally substituted with cyano, hydroxyl, halo, nitro, carboxyaldehyde, carboxyl, alkoxy, oxo, or alkyl.

41. (canceled)

42. The method of claim 18, further comprising:
casting the hybrid electrolyte composition as a film; and
optionally healing the film by heating to a temperature of from about 100° C. to about 190° C.

43. (canceled)

44. (canceled)

45. An electrode comprising:
an in situ cross-linked matrix comprising a binder and a plurality of crosslinkers, wherein the crosslinkers form a thermally reversible bond within the matrix and wherein the thermally reversible bond does not generate a byproduct;
an electrochemically active material;
ionically conductive particles; and
optionally a carbon additive.

46. A composition, comprising:
a separator comprising ion conducting inorganic material and an in situ cross-linked first matrix; and
an electrode of claim 45, wherein the electrode comprises an in situ cross-linked second matrix, wherein the first matrix and the second matrix comprise a binder and a plurality of crosslinkers, wherein the crosslinkers form a thermally reversible bond between the matrices, and wherein the thermally reversible bond does not generate a byproduct.

47. (canceled)
